(19) United States
(12) Patent Application Publication
(10) Pub. No.: US 2017/0270610 A1
(43) Pub. Date: Sep. 21, 2017

(54) Portfolio Management

(71) Applicant: Upper Room Technology, Inc., Yorkville, IL (US)

(72) Inventors: Matthew D. Kee, De Pere, WI (US); Jack D. Kee, Yorkville, IL (US)

(73) Assignee: Upper Room Technology, Inc., Yorkville, IL (US)

(21) Appl. No.: 15/613,706

(22) Filed: Jun. 5, 2017

Related U.S. Application Data
(63) Continuation of application No. PCT/US2017/017422, filed on Feb. 10, 2017.
(60) Provisional application No. 62/293,472, filed on Feb. 10, 2016.

(51) Int. Cl. G06Q 40/06; G06F 3/0482; G06Q 40/04

(52) U.S. Cl. CPC G06Q 40/06; G06Q 40/04; G06F 3/0482

(57) ABSTRACT

A portfolio management solution, which can evaluate hypothetical trades and recommend trades (e.g., buy, sell, swap transactions) for one or more portfolios based on target and current attributes of the portfolio(s) and attributes of the investment(s) involved in the hypothetical trades, is described. Portfolio contribution data can be generated, which represents a contribution to a value for each of a plurality of portfolio attributes of the investment portfolio made by the investments in the portfolio. The hypothetical trades can be scored based on an effect of the hypothetical trade on the plurality of attributes of the portfolio in comparison to a plurality of target attributes for the investment portfolio. The solution can assist a bond manager in more efficiently evaluating potential trades for a plurality of bond portfolios, which can result in better trades being completed and the bond portfolios being more aligned with their goals.

### REFERENCE TO RELATED APPLICATIONS

The present patent application is a continuation of International Application No. PCT/US2017/017422, filed on 10 Feb. 2017, which claims the benefit of U.S. Provisional Application No. 62/293,472, filed on 10 Feb. 2016, each of which is hereby incorporated by reference.

### TECHNICAL FIELD

The disclosure relates generally to investment portfolio management, and more particularly, to providing trade recommendations based on a target portfolio.

### BACKGROUND ART

A portfolio includes investments that are collectively intended to meet a set of investment goals of the portfolio. A portfolio can include one or more of various types of assets, such as securities (e.g., stocks, bonds, commodities, and/or the like), cash, real property, and/or the like. The portfolio can be owned by an individual investor, an investment company, and/or the like. Furthermore, the portfolio itself can be a form of investment, such as an investment fund (e.g., a mutual fund). As part of managing a portfolio, a portfolio manager will buy and sell various assets of the portfolio in a manner intended to best meet the investment goals of the portfolio.

Buying and selling different types of assets can differ significantly. For example, buying and selling bonds differs significantly from buying and selling equities (e.g., stocks) as bonds are much more complicated than stocks and are sold in a very different marketplace from that of stocks. While a stock has just a few descriptive characteristics (name, dividend) and a price, a bond has multiple characteristics, such as coupon, callability and schedule, maturity, sector, rating, bond owner, bond issuer, state, tax status, and many more. Bonds also lack a single marketplace in which buying and selling is conducted. Related to this, bonds have a significantly lower liquidity than stocks. In the bond market, even professional investors can have difficulty locating a bond they want to buy. Additionally, even when an appropriate bond is found, there may be a question as to what quantity would be available. Conversely, when looking to sell a bond, one may need to make a significant effort to find an interested counterparty. Finally, bond prices are not nearly as transparent as stock prices.

A typical bond trader is in charge of tens to thousands of client portfolios. Each portfolio in turn, contains a few bonds to several hundred bonds representing different investment preferences. Multiply each portfolio by the number of clients one bond trader manages, and you realize that the typical bond trader has a significant workload. Furthermore, every bond trading firm has its own investment objectives to which portfolios must be targeted, while they take client preferences into account. As such, a bond trader works all day to align his or her clients' portfolios with the corresponding investment objective(s).

As the market moves or a client desires to alter the portfolio, the trader buys bonds from the market or sells bonds from the current portfolios. In each case, the trader has a direction that he wants to take the current portfolio towards a set of goals for the portfolio. For example, the direction can be any combination of many factors, such as: higher treasury exposure; higher average duration; higher average maturity; less exposure to healthcare sector bonds; and/or the like. As one can see, the bond trader can be managing multiple goals concurrently, with potentially millions of dollars involved in a transaction. In addition, the bond trader needs to comply with legal parameters stemming from contracts with clients, Securities and Exchange Commission (SEC) guidelines, and the like.

### SUMMARY OF THE INVENTION

Aspects of the invention provide an improved solution for evaluating complex assets and/or presenting information regarding a portfolio including complex assets to a user. An embodiment of the solution can improve an efficiency and/or comprehensiveness with which a computer system can compute an effect a particular complex asset has or would have on the portfolio. Furthermore, an embodiment of the solution can provide a result of the evaluation for presentation to a user in a manner that allows the user to make a more informed, faster decision regarding changes, if any, to be made to the portfolio. An embodiment of the solution can compare the results of numerous complex assets available for purchase and/or sale along with various combinations of such purchases and/or sales and present a set of proposals for consideration by the user. In this manner, an embodiment of the solution can enable the computer system to provide valuable information for use in the decision-making process when purchasing and/or selling complex assets in a fast-moving and complex trading environment.

An embodiment can be directed to provide a portfolio management solution, which can evaluate complex assets and make buy and/or sell recommendations for a portfolio based on one or more target attributes of the portfolio and the corresponding assets in the portfolio and/or available assets. In a particular implementation, aspects of the invention provide a solution for automating various aspects of managing a portfolio of bonds, which can consider any number of attributes of the bonds and can make buy and/or sell recommendations and/or provide buy and/or sell analysis in real-time to assist the portfolio manager with managing the bond portfolio.

A first aspect of the invention provides a computer-implemented method of managing an investment portfolio including a plurality of portfolio bonds, the method comprising: generating, by a computer system including at least one computing device, investment portfolio contribution data for the plurality of portfolio bonds in the investment portfolio, wherein the investment portfolio contribution data includes, for each of the plurality of portfolio bonds in the investment portfolio, a contribution to an attribute value for each of a plurality of portfolio attributes of the investment portfolio; generating, by the computer system, trade evaluation data for a hypothetical trade for the investment portfolio using the investment portfolio contribution data, wherein the trade evaluation data includes a hypothetical sale of a portfolio bond in the investment portfolio, wherein the trade evaluation data includes data regarding an effect of the hypothetical trade on the plurality of portfolio attributes of the investment portfolio in comparison to a plurality of target attributes of a target portfolio for the investment portfolio; and providing, by the computer system, the trade evaluation data for use by a user in evaluating the hypothetical trade.

A second aspect of the invention provides a method of managing information for an investment portfolio including a plurality of portfolio investments and information regarding a set of hypothetical trades involving the investment portfolio, the method comprising: displaying, on a graphical user interface, a trade score for each hypothetical trade in the set of hypothetical trades, wherein the trade score represents an effect of the hypothetical trade on a plurality of portfolio attributes of the investment portfolio in comparison to a plurality of target attributes for the investment portfolio; concurrently displaying, on the graphical user interface, an available investment score for an available investment in a plurality of available investments for purchase, wherein the available investment score represents an effect on the plurality of portfolio attributes of the investment portfolio in comparison to the plurality of target attributes for the investment portfolio resulting from including the available investment in the investment portfolio; concurrently displaying, on the graphical user interface, a portfolio investment score for a portfolio investment of the plurality of portfolio investments, wherein the portfolio investment score represents an effect on the plurality of portfolio attributes of the investment portfolio in comparison to the plurality of target attributes for the investment portfolio resulting from removing the portfolio investment from the investment portfolio.

A third aspect of the invention provides a computer system for managing an investment portfolio including a plurality of portfolio bonds, and facilitating trades for the investment portfolio that efficiently align the investment portfolio with target attributes for the investment portfolio, the computer system including: a set of computing devices including means for managing a trade evaluation graphical user interface, the means for managing the trade evaluation graphical user interface including: generating investment portfolio contribution data for the plurality of portfolio bonds in the investment portfolio, wherein the investment portfolio contribution data includes, for each of the plurality of portfolio bonds in the investment portfolio, a contribution to a value for each of a plurality of portfolio attributes of the investment portfolio; generating trade evaluation data for a hypothetical trade for the investment portfolio using at least one of: the investment portfolio contribution data or available bonds data, wherein the trade evaluation data includes a hypothetical trade score representing an effect of the hypothetical trade on the plurality of portfolio attributes of the investment portfolio in comparison to a plurality of target attributes for the investment portfolio; generating the trade evaluation graphical user interface including: the hypothetical trade score, an available bond score for an available bond available for purchase, and a portfolio investment score for a portfolio bond of the plurality of portfolio bonds; and providing the trade evaluation graphical user interface for presentation to a user evaluating the hypothetical trade.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative environment for managing a portfolio according to an embodiment.

FIG. 2 shows an illustrative data flow diagram according to an embodiment.

FIGS. 3A and 3B show illustrative data flow diagrams according to embodiments.

FIG. 4 shows an illustrative process for generating proposed trade data according to an embodiment.

FIG. 5 shows an illustrative graph of various bonds and a bond portfolio according to an embodiment.

FIG. 6 shows various illustrative bond vectors and vector calculations according to an embodiment.

FIG. 7 shows various illustrative portfolio vectors and vector calculations according to an embodiment.

FIGS. 8A and 8B show illustrative vector calculations for evaluating a sale and a purchase, respectively, according to an embodiment.

FIG. 9 shows illustrative vector calculations for generating a distance derivative vector for a bond with respect to an optimal portfolio according to an embodiment.

FIGS. 10A and 10B show illustrative interfaces presented to a user in an embodiment.

FIGS. 11A-11G show an illustrative series of user interfaces according to embodiments.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a portfolio management solution, which can evaluate complex assets and make buy and/or sell recommendations for a portfolio based on one or more target attributes of the portfolio and the corresponding assets in the portfolio and/or available assets. The portfolio can include one or more types of assets. At least one asset of the portfolio can be a complex asset, for which numerous attributes are relevant to considering whether to buy or sell the complex asset for a portfolio. The discussion herein primarily uses bonds as an illustrative complex asset. However, it is understood that the invention is not limited to bonds and can be used to generate buy and/or sell recommendations of various types of assets, including commodities, stocks, real property, future contracts, etc.

In an embodiment, various attributes of an asset (e.g., a complex asset) are represented as an asset vector. Attributes of a portfolio including multiple assets also can be represented using a portfolio vector. The portfolio vector can be created by combining the asset vectors of the assets in the portfolio using standard vector mathematical operations. Attributes of an optimal (or target) portfolio also can be represented using an optimal vector, and buy/sell recommendations can be generated by evaluating the portfolio and/or asset with respect to the optimal portfolio using the corresponding vectors.

Use of a vector to represent various attributes of a complex asset and a portfolio including complex assets can provide various benefits not previously addressed in the prior art. For example, a vector representing a contribution of a particular asset to the value of each of multiple attributes of a portfolio including the asset can be created and used to quickly calculate the impact of a sale or purchase of the asset to the overall portfolio. Similarly, the attributes of an asset can be readily adjusted to alter a relative influence each attribute has on an evaluation of a portfolio with its corresponding optimal portfolio. Using standard vector math, different portfolios can be ranked based on their corresponding variations from an optimal portfolio for each portfolio, different assets can be ranked according their desirability to sell from a portfolio or buy for a portfolio as defined by how the assets affect the portfolio, and/or the like. Furthermore, an overall effect of a transaction including the sale and/or purchase of one or more assets can be readily calculated to rank possible transactions for a portfolio. Such rankings can account for an effect on the entire portfolio that such a transaction will have considering all of the attributes or only a subset of one or more attributes.

An embodiment of the invention can assist a user responsible for managing multiple portfolios. In particular, the user can be presented with information identifying the portfolios most in need of realignment with their optimal portfolio, a list of potential trades that are most helpful to aligning portfolios of the multiple portfolios with their optimal portfolios, etc. Additionally, such trades can include the purchase and/or sale of assets between the multiple portfolios being managed by the user.

In a particular implementation, aspects of the invention provide a solution for automating various aspects of managing a portfolio of bonds, which can consider any number of attributes of the bonds and can make buy and/or sell recommendations and/or provide buy and/or sell analysis in real-time to assist the portfolio manager with managing the bond portfolio. As used herein, unless otherwise noted, the term “set” means one or more (i.e., at least one) and the phrase “any solution” means any now known or later developed solution. As used herein, unless otherwise noted, the term “trade” refers to transactions including: only the purchase of one or more assets; only the sale of one or more assets; the purchase and sale of assets; and a swap of assets.

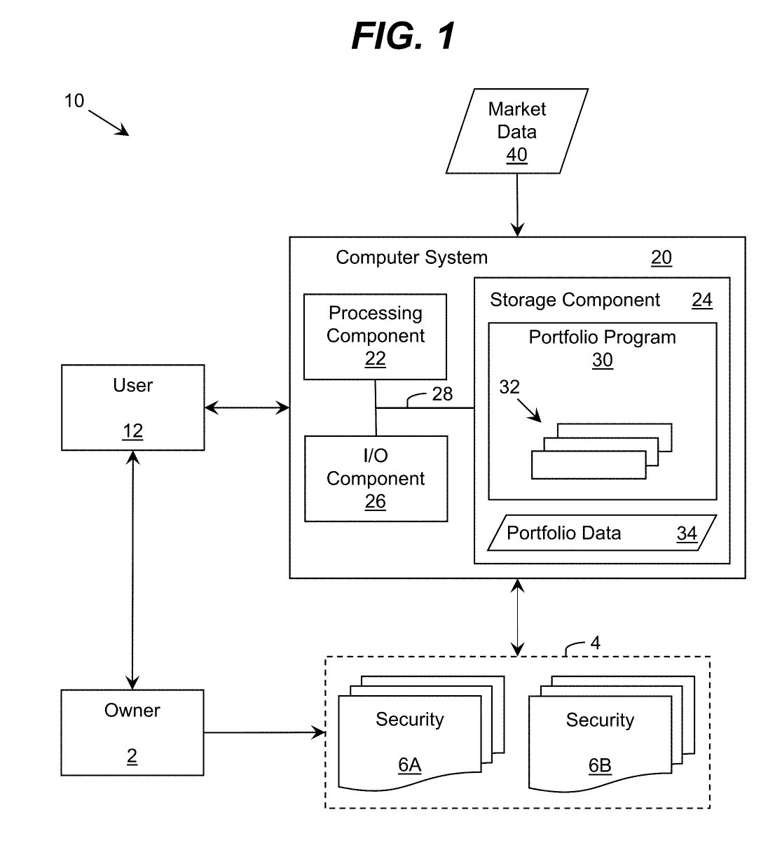

Turning to the drawings, FIG. 1 shows an illustrative environment 10 for managing a portfolio 4 according to an embodiment. To this extent, the environment 10 includes a computer system 20 that can perform a process described herein in order to manage a portfolio 4. In particular, the computer system 20 is shown including a portfolio program 30, which makes the computer system 20 operable to manage the portfolio 4 by performing a process described herein.

The computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, the processing component 22 executes program code, such as the portfolio program 30, which is at least partially fixed in storage component 24. While executing program code, the processing component 22 can process data, which can result in reading and/or writing transformed data from/to the storage component 24 and/or the I/O component 26 for further processing. The pathway 28 provides a communications link between each of the components in the computer system 20. The I/O component 26 can comprise one or more human I/O devices, which enable a human user 12 to interact with the computer system 20 and/or one or more communications devices to enable a system user 12 to communicate with the computer system 20 using any type of communications link. To this extent, the portfolio program 30 can manage a set of interfaces (e.g., graphical user interface(s), application program interface, and/or the like) that enable human and/or system users 12 to interact with the portfolio program 30. Furthermore, the portfolio program 30 can manage (e.g., store, retrieve, create, manipulate, organize, present, etc.) the data, such as portfolio data 34, using any solution.

In any event, the computer system 20 can comprise one or more general purpose computing articles of manufacture (e.g., computing devices) capable of executing program code, such as the portfolio program 30, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the portfolio program 30 can be embodied as any combination of system software and/or application software.

Furthermore, the portfolio program 30 can be implemented using a set of modules 32. In this case, a module 32 can enable the computer system 20 to perform a set of tasks used by the portfolio program 30, and can be separately developed and/or implemented apart from other portions of the portfolio program 30. As used herein, the term “component” means any configuration of hardware, with or without software, which implements the functionality described in conjunction therewith using any solution, while the term “module” means program code that enables a computer system 20 to implement the actions described in conjunction therewith using any solution. When fixed in a storage component 24 of a computer system 20 that includes a processing component 22, a module is a substantial portion of a component that implements the actions. Regardless, it is understood that two or more components, modules, and/or systems may share some/all of their respective hardware and/or software. Furthermore, it is understood that some of the functionality discussed herein may not be implemented or additional functionality may be included as part of the computer system 20.

When the computer system 20 comprises multiple computing devices, each computing device can have only a portion of the portfolio program 30 fixed thereon (e.g., one or more modules 32). However, it is understood that the computer system 20 and the portfolio program 30 are only representative of various possible equivalent computer systems that may perform a process described herein. To this extent, in other embodiments, the functionality provided by the computer system 20 and the portfolio program 30 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 20 includes multiple computing devices, the computing devices can communicate over any type of communications link. Furthermore, while performing a process described herein, the computer system 20 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

As discussed herein, the portfolio program 30 enables the computer system 20 to manage the portfolio 4. As used herein, it is understood that a portfolio 4 comprises a set of investments (assets) owned by an owner 2. The owner 2 can be an individual, a group of individuals, an entity, and/or the like. To this extent, the portfolio 4 can include one or more types of securities 6A, 6B. For example, the securities 6A can comprise bonds included in the portfolio 4, and the securities 6B can comprise stocks included in the portfolio 4. In addition to securities 6A, 6B, the portfolio 4 can include other types of investments including, for example, cash, bank accounts, fixed income investments, insurance policies, real property, collectibles, and/or the like. It is understood that the portfolio 4 can represent all investments owned by the owner 2 or only a portion of the investments owned by the owner 2, e.g., a defined set of investments owned for a designated purpose of the owner 2.

Regardless, a user 12 can use the computer system 20 to manage the portfolio 4 for the owner 2. To this extent, the owner 2 can communicate a set of objectives for the portfolio 4, and the user 12 can use the computer system 20 to create a portfolio 4 that best meets the set of objectives. While the user 12 and owner 2 are shown separately, it is understood that the owner 2 can be the same as the user 12. In an embodiment, the user 12 is a professional investment manager, who concurrently manages the portfolios 4 of many different owners 2. The computer system 20 can generate and provide for display to the user 12 (e.g., professional investment manager) various graphical user interfaces that present information created by the computer system 20 and enable input from the user 12 to manage the portfolio(s) 4 as described herein. However, it is understood that the user 12 can comprise another computer system, with which the computer system 20 communicates, with or without input from a human user, to manage the portfolio(s) 4.

Further aspects of the invention are described in conjunction with managing a set of bonds 6A included within the portfolio 4 using the computer system 20. However, it is understood that aspects of the invention described herein can be utilized to manage other types of securities and/or non-security investments.

In an embodiment, the portfolio data 34 can include various data regarding the set of bonds 6A in the portfolio 4 as well as data corresponding to a set of goals of the owner 2 with respect to the set of bonds 6A and/or portfolio 4. For example, the computer system 20 can automatically analyze and/or assist the user 12 in analyzing the portfolio data 34 in conjunction with market data 40 to generate a set of possible changes to the set of bonds 6A of the portfolio 4. Such possible changes can include the purchase of one or more additional bonds 6A, the sale of one or more bonds 6A, a swap of bonds 6A, and/or the like.

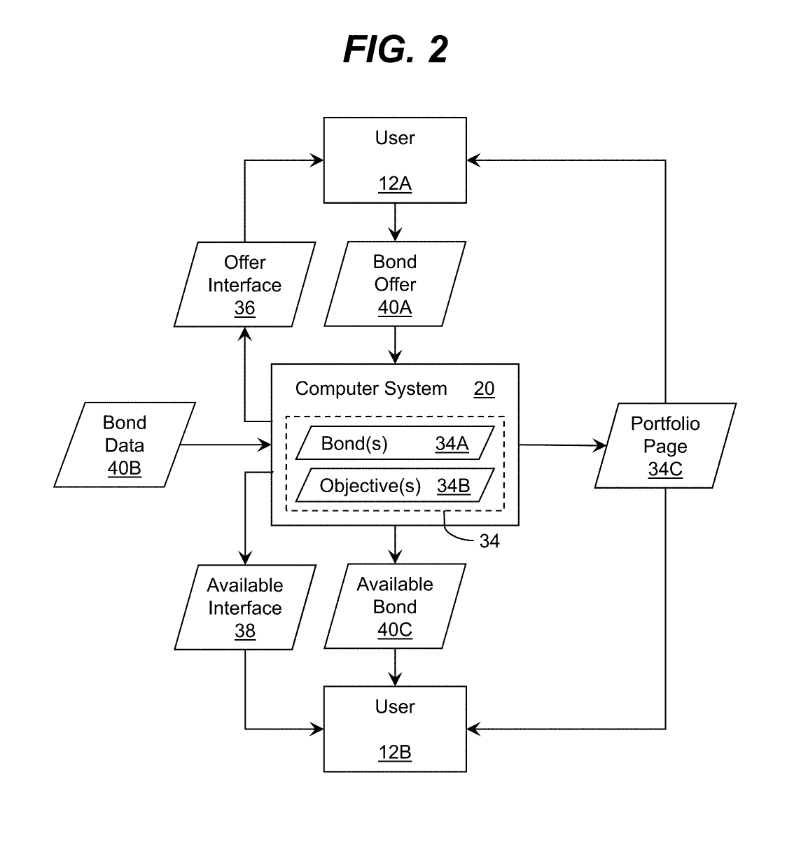

In an embodiment, the computer system 20 can facilitate communications between bond dealers, who can be looking to sell, purchase, swap, and/or the like, bonds, such as bonds 6A from one or more portfolios 34 being managed by a dealer. To this extent, FIG. 2 shows an illustrative data flow diagram according to an embodiment. In this case, the computer system 20 is shown communicating with two users 12A, 12B. For clarity, the user 12A is a user seeking to sell bond(s), while the user 12B is a user seeking to purchase bond(s). However, it is understood that each user 12A, 12B can be looking to buy and/or sell bond(s).

Regardless, the user 12A can provide bond offer data 40A to the computer system 20 using any solution. The bond offer data 40A can include any combination of various data, which is sufficient to enable the computer system 20 to provide available bond data 40C for use by the user 12B in determining whether to purchase the corresponding bond. In an embodiment, the available bond data 40C includes: data uniquely identifying the bond; data identifying a quantity of the bond available; and data identifying a price for the bond. The available bond data 40C also can include additional data, such as data identifying the seller of the bond (the user 12A), a duration of the offer, additional information regarding the corresponding bond, and/or the like.

In an embodiment, the computer system 20 can generate an offer interface 36, which allows the user 12A to define the bond offer data 40A and transmit the bond offer data 40A for processing by the computer system 20. To this extent, the offer interface 36 can include a set of interface controls, which enable the user 12A to provide the bond offer data 40A, including, data identifying the bond, a quantity available, a price, identification information of the user 12A, information regarding the offer, information regarding the bond, and/or the like. In a more particular embodiment, the offer interface 36 can enable the user 12A to provide all of the available bond data 40C in the bond offer data 40A. In this manner, the computer system 20 can receive the bond offer data 40A and provide the available bond data 40C without utilizing any external data sources.

In an alternative embodiment, the computer system 20 can obtain some or all of the available bond data 40C from another data source. For example, the computer system 20 can obtain bond data 40B from an external data source, such as a third party bond data source, and/or from a bond database managed by the computer system 20. In either case, the computer system 20 can use the bond data 40B to generate at least a portion of the available bond data 40C and/or to generate the offer interface 36. To this extent, the offer interface 36 can include a list of bonds identified in the bond data 40B, from which the user 12A can select the corresponding available bond. Furthermore, the computer system 20 can use the bond data 40B to provide additional information regarding the corresponding bond (e.g., one or more attributes of the bond) in the available bond data 40C.

In an embodiment, when the user 12A manages a portfolio 34 using the computer system 20, the computer system 20 can generate a portfolio page 34C, which enables the user 12A to generate bond offer data 40A using any solution. For example, the portfolio page 34C can include a set of user interface controls for displaying bond data 34A for each bond included in the portfolio 34 and for enabling the user 12A to identify one or more bonds in the portfolio 34 available for sale. To this extent, the portfolio page 34C can enable the user 12A to define various bond offer data 40A including an offer price, a quantity (e.g., all of the holdings or a portion thereof), a duration of the offer, and/or the like.

The computer system 20 can further assist the user 12A in defining the bond offer data 40A. For example, once a user 12A has identified an available bond using the offer interface 36 and/or portfolio page 34C as described herein, the computer system 20 can retrieve and provide bond data 40B for the corresponding bond indicating other offers of the bond which are currently available or recently made. Such bond data 40B can assist the user 12A in determining current/recent market pricing for the bond. Additionally, the computer system 20 can obtain similar bond data 40B for other bonds that are similar to the available bond, which the user 12A can review to obtain some understanding of the overall market for bonds of a similar type as the available bond.

The computer system 20 can provide the available bond data 40C for presentation to the user 12B using any solution. For example, the computer system 20 can generate an available interface 38, which includes some or all of the available bond data 40C for the bond(s) available for purchase by the user 12B. In an embodiment, when the user 12B manages a portfolio 34 using the computer system 20, the computer system 20 can generate a portfolio page 34C, which enables the user 12B to view the current portfolio 34 along with available bond data 40C for one or more bonds. In this case, the portfolio page 34C can enable the user 12B to evaluate an impact on the portfolio 34 of the purchase of an available bond, a swap of an available bond with a bond in the portfolio 34, and/or the like.

In an embodiment, the available interface 38 and/or the portfolio page 34C can include a user interface control for enabling the user 12B to request additional available bond data 40C regarding a bond included in the available interface 38, which the computer system 20 can obtain from the bond offer data 40A and/or bond data 40B and provide for presentation to the user 12B. Furthermore, the available interface 38 and/or the portfolio page 34C can include a user interface control for enabling the user 12B to seek to purchase an available bond, e.g., by generating a purchase request, a swap request, and/or the like, which the computer system 20 can transmit to the user 12A. Additionally, the computer system 20 can facilitate further communications between the users 12A, 12B using any solution, in order to confirm a purchase, negotiate a purchase/swap, and/or the like.

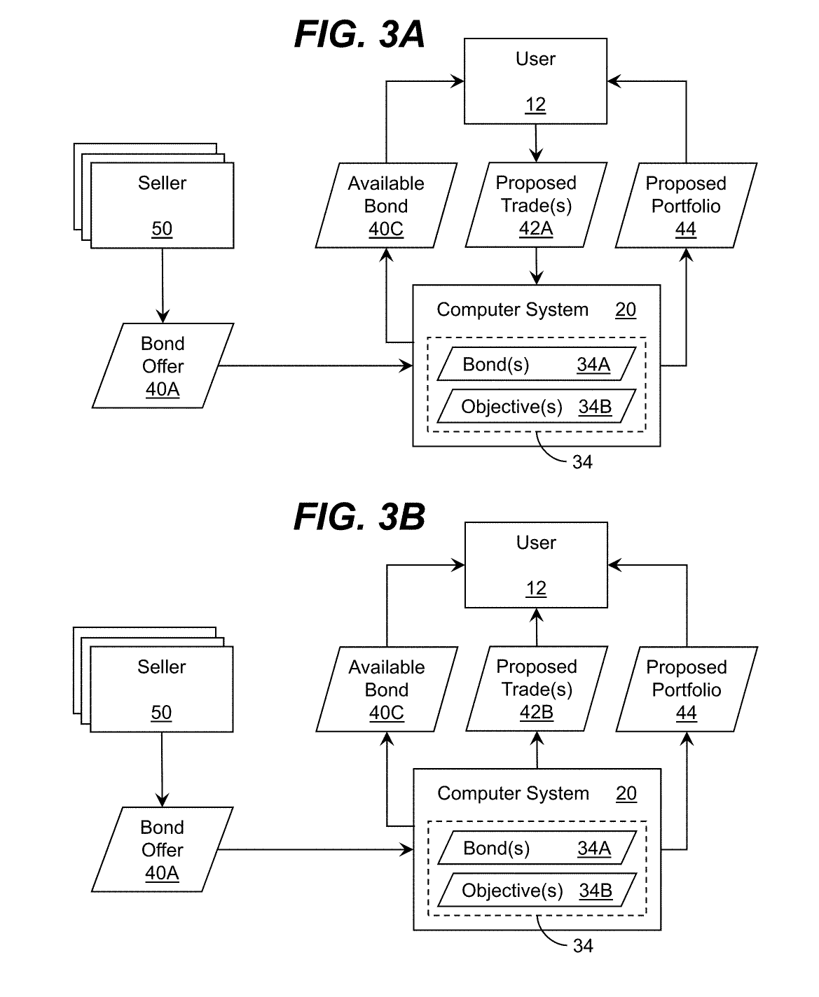

As discussed herein, the computer system 20 can enable the users 12A, 12B to evaluate an effect of a proposed bond trade (e.g., purchase, sale, swap, and/or the like) on a portfolio 34. To this extent, FIGS. 3A and 3B show illustrative data flow diagrams according to embodiments. As illustrated, each seller 50 in a group of sellers can provide bond offer data 40A, which includes information regarding a set of bonds available for purchase. The bond offer data 40A can include information for each of the bond(s) available, including data uniquely identifying the bond, data indicating pricing, and data indicating a quantity available. The computer system 20 can aggregate the bond offer data 40A received from various sellers 50 and transform the bond offer data 40A into available bond data 40C for presentation to the user 12. To this extent, the transformation can include adding additional bond data 40B (FIG. 2) to the bond offer data 40A, highlighting certain available bond data 40C based on a set of criteria, sorting the available bond data 40C according to a set of criteria, and/or the like.

To this extent, the available bond data 40C can include information identifying each bond available as well as its corresponding pricing and quantity available. Furthermore, the available bond data 40C can include multiple entries for a particular bond, each corresponding to one of a plurality of sellers 50 of the available bond. Alternatively, the computer system 20 can generate available bond data 40C which aggregates information from multiple sellers 50 of a particular bond into a single entry. In this case, the pricing information can include a total amount for purchasing the entire quantity of the particular bond available, an average price for the bond, low/high prices for purchasing the bond, and/or the like. In an embodiment, the available bond data 40C includes a set of user interface controls, which can enable the user 12 to selectively change one or more aspects of the available bond data 40C. For example, the user 12 can define one or more filters to be used for the available bond data 40C, re-sort the data according to a different criteria (e.g., pricing, quantity, seller, etc.), request additional data regarding one or more available bonds, and/or the like.

As shown in FIG. 3A, the user 12 can generate proposed trade data 42A using the available bond data 40C and the portfolio data 34. For example, the user 12 can review the available bond data 40C and current portfolio data 34 and identify one or more possible trades, which appear to meet one or more objectives of the portfolio as defined in the objectives data 34B. The proposed trade data 42A can include any type of bond trade, including: a purchase of one or more bonds identified in the available bond data 40C; a sale of one or more bonds in the portfolio; a swap of an available bond with a bond in the portfolio; and/or the like. Once proposed trade data 42A for a set of proposed trades has been defined, the user 12 can submit the proposed trade data 42A for processing by the computer system 20 using any solution.

The computer system 20 can process the proposed trade data 42A and generate proposed portfolio data 44 for presentation to the user. To this extent, the proposed portfolio data 44 can include data regarding the portfolio assuming that the proposed trade(s) defined in the proposed trade data 42A have been concluded. For example, the computer system 20 can add or remove bond data 34A from the portfolio data 34 and reevaluate the resulting revised portfolio data using the objective data 34B for the portfolio. In an embodiment, the proposed portfolio data 44 can include data regarding the set of bonds in the portfolio should the proposed trade(s) be completed and/or data regarding an effect the proposed trade(s) would have on the portfolio. For example, the computer system 20 can include data regarding whether the proposed trade(s), as a group and/or individually, would move the portfolio closer to or further away from one or more of the objectives of the portfolio defined in the objective data 34B in the proposed portfolio data 44. In this manner, the user 12 can evaluate whether the proposed trade(s) are desirable before proceeding further with attempting to initiate a trade with another party, such as a seller 50.

As shown in FIG. 3B, an embodiment includes the computer system 20 generating proposed trade data 42B for a set of proposed trades for a portfolio and providing the proposed trade data 42B for presentation to the user 12 using any solution. In this case, the computer system 20 can receive and process the bond offer data 40A and portfolio data 34 to determine a set of proposed trades for the corresponding portfolio. The set of proposed trades can comprise one or more trades (purchase, sell, swap, and/or the like), which will result in the portfolio more closely aligning with one or more of a set of objectives defined in the objective data 34B of the portfolio. While data corresponding to a single set of proposed trades and a corresponding proposed portfolio as discussed herein, it is understood that the computer system 20 can generate data corresponding to any number of alternative proposed portfolios and sets of proposed trades for presentation to the user 12.

The computer system 20 can provide both the proposed trade data 42B and the proposed portfolio data 44 concurrently in an interface, which will allow the user 12 to readily evaluate both the proposed trade data 42B and the proposed portfolio data 44. Additionally, the computer system 20 can provide available bond data 40C, which can include data generated from the bond offer data 40A and relied upon by the computer system 20 in generating the proposed trade data 42B. For example, when the proposed trade data 42B includes one or more proposed sales or swaps of a bond from the portfolio, the available bond data 40C can include data on other current bond offers 40A, from which the computer system 20 generated the proposed trade.

Regardless, the user 12 can request one or more changes to the set of proposed trades, request that the computer system 20 generate a different set of proposed trades (e.g., using one or more adjusted objectives, excluding/including particular bond(s), modifying or replacing a particular trade, etc.), and/or the like. In response, the computer system 20 can generate revised proposed trade data 42B and proposed portfolio data 44, which can be presented to the user 12. In this manner, the user 12 can readily review and define a set of trades to be executed for a portfolio.

In an embodiment, the computer system 20 can calculate a set of objective (data-based) scores using the portfolio data 34, which the computer system 20 can use to evaluate the proposed trade data 42A, generate the proposed trade data 42B, generate the proposed portfolio data 44, and/or the like. Each objective score can be calculated using some or all of the bond data 34A and objective data 34B for the portfolio data 34. To this extent, an objective score can indicate a desired set of attributes for the portfolio as defined by the objective data 34B, an actual set of attributes for the portfolio as defined by the bond data 34A, a difference between the actual set of attributes and the desired set of attributes, and/or the like.

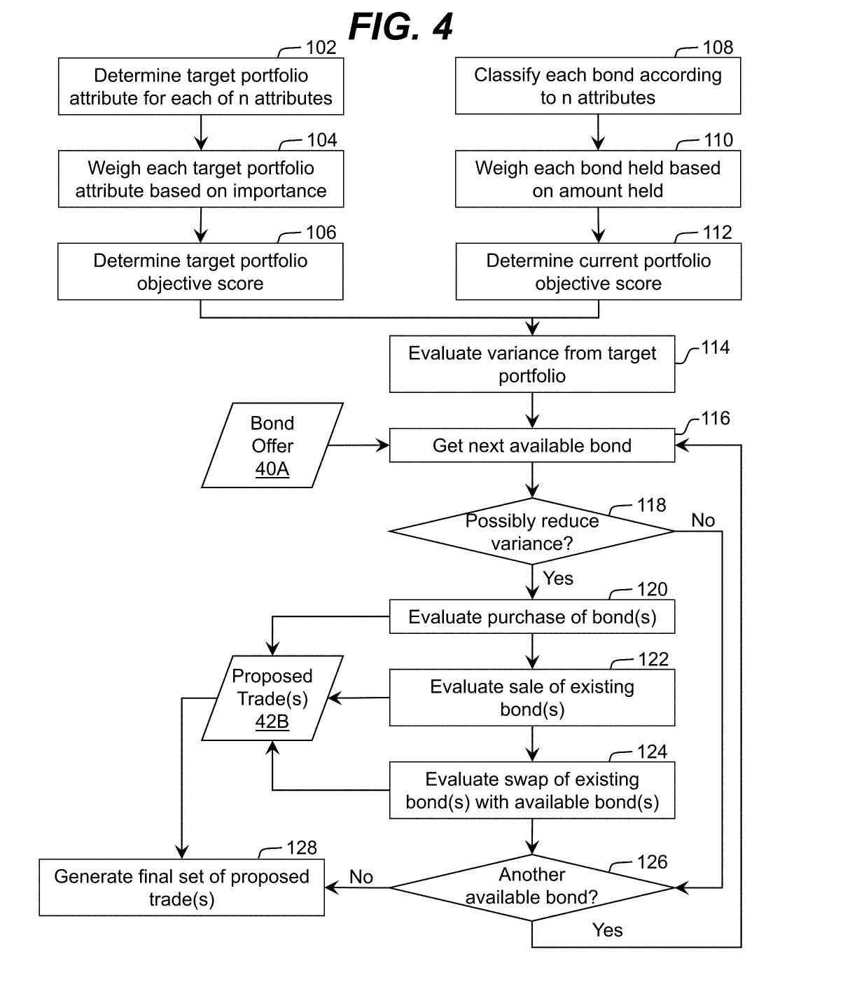

In an embodiment, the computer system 20 can use two objective scores for a portfolio, one based on the objective(s) for the portfolio, and one based on the bonds in the portfolio, to generate the set of proposed trades 42B. To this extent, FIG. 4 shows an illustrative process for generating the proposed trade data 42B, which can be implemented by the computer system 20, according to an embodiment. In action 102, the computer system 20 can determine a target portfolio attribute for each of n attributes using any solution. For example, the objective data 34B for the portfolio can define various objectives for the portfolio, one or more of which can affect an attribute of the portfolio. The computer system 20 can evaluate and quantify each such objective with respect to the attribute to generate an attribute value corresponding to each objective. Subsequently, if necessary, the computer system 20 can combine (e.g., average) the attribute values for multiple objectives to determine a value for the target portfolio attribute.

In action 104, the computer system 20 can weigh each target portfolio attribute according to an importance of the attribute. In an embodiment, the objective data 34B includes data corresponding to the importance of the attributes, e.g., as defined by the user 12. The computer system 20 also can automatically determine the relative importance of one or more attributes using any solution. For example, portfolio data 34 for a portfolio can initially include objective data 34B defining a set of default objectives. Subsequently, the user 12 can define one or more objectives and/or leave an objective undefined, in which the corresponding default objective can be utilized. In this case, the computer system 20 can infer that the explicitly defined objectives have a higher importance to the user 12 than the objective(s) for which the default is utilized.

In action 106, the computer system 20 can determine a target portfolio objective score using the target portfolio attribute(s) and weighted importance of each target portfolio attribute. For example, the computer system 20 can combine one or more of the target portfolio attributes using a weighted average, and/or the like. In an embodiment, the target portfolio objective score is a multi-dimensional value, which can include up to n values (e.g., one for each attribute) and can include weighting information for each value of the multi-dimensional value.

The computer system 20 can perform a similar process using the bond data 34A for the portfolio. To this extent, in action 108, the computer system 20 can classify each bond according to the same n attributes discussed herein. In an embodiment, the computer system 20 can manage or access a data store, such as a database, or the like, which stores classification information for many of the bonds that may be available for purchase. In this case, the computer system 20 can retrieve the classification information from the data store.

In action 110, the computer system 20 can weigh each bond held in the portfolio based on the amount of the bond(s) held. In an embodiment, the computer system 20 can use a total value of the bond held, e.g., by multiplying the number of bonds by an estimate of the current value of the bond (e.g., using the bond offer data 40A). In action 112, the computer system 20 can determine an objective score for the current portfolio using any solution. For example, the computer system 20 can calculate a multi-dimensional value for the objective score using the attribute information, which can include the weighted importance of the attributes, and weighting information for one or more of the bonds (e.g., each bond) in the portfolio.

In action 114, the computer system 20 can evaluate a variance of the current portfolio from a target portfolio using the corresponding objective scores. For example, the computer system 20 can determine how close the current portfolio is to a target attribute or group of attributes, e.g., by comparing the objective scores for the corresponding attribute or group of attributes. It is understood that the computer system 20 can store data corresponding to the target objective score, the current portfolio objective score, and/or the variance as portfolio data 34. In this case, the stored data can be updated in response to a change in the portfolio data 34, such as a change in the bond data 34A or a change in the objective data 34B. To this extent, it is understood that, after an initial evaluation, the computer system 20 can perform some or all of the actions 102-114 only in response to a change in the portfolio data 34 for the portfolio, which will impact the determination. Alternatively, the computer system 20 can periodically perform actions 110-114 in response to changes in the market conditions for a corresponding bond, e.g., as indicated by changing bond offer data 40A.

The computer system 20 can use the objective scores for the target portfolio and the current portfolio and the corresponding variance to analyze bond offer data 40A and generate a set of proposed trades 42B. To this extent, in action 116, the computer system 20 can obtain bond offer data 40A for a bond available for purchase. The computer system 20 can evaluate all bond offer data 40A for a given bond, which may be from a plurality of sellers 50 at differing prices/quantities, together and/or separately.

In action 118, the computer system 20 can initially determine whether the bond offer data 40A is potentially useful in reducing variance between the target portfolio and the current portfolio. To this extent, when the purchase of the bond will only increase the variance, the computer system 20 can determine that further consideration of the bond is not merited. However, when the bond is in the current portfolio, the computer system 20 can further consider whether a sale of the bond may be appropriate based on the market for the bond (as indicated by the current bond offer data 40A).

When the computer system 20 determines that the bond offer data 40A may possibly be utilized to reduce the variance, in action 120, the computer system 20 can evaluate a purchase of some or all of the bonds indicated as being available in the bond offer data 40A. When such a purchase can reduce the variance, the computer system 20 can generate proposed trade data 42B for one or more possible purchases of the bond.

In action 122, the computer system 20 can evaluate a sale of one or more bonds currently held in the portfolio. For example, the computer system 20 can evaluate the bond offer data 40A for a bond currently held in the portfolio and determine whether some or all of the holdings for the bond should be sold. Additionally, when the proposed trade data 42B includes one or more proposed purchases, the computer system 20 can determine which bond(s) in the current portfolio can be sold to fund the purchase, further reduce the variance, and/or the like. As a result, the computer system 20 can generate proposed trade data 42B for one or more possible sales of bonds in the portfolio.

In action 124, the computer system 20 can evaluate whether a swap of one or more existing bonds in the portfolio with one or more available bonds will result in a reduced variance. For example, a purchase of a first bond may only reduce variance if it can be accompanied by a sale of a second bond currently held in the portfolio. When the computer system 20 determines that sufficient quantities of the first bond and the second bond are available to propose a swap of a comparable value, the computer system 20 can generate proposed trade data 42B for the swap.

In action 126, the computer system 20 can determine whether another available bond requires analysis. If so, flow can return to action 116 and the corresponding bond offer data 40A for the next available bond can be analyzed. Once evaluation of all of the bond offer data 40A is complete, in action 128, the computer system 20 can generate one or more sets of proposed trades, and provide the proposed trade data 42B for presentation to the user 12. For example, computer system 20 can generate one or more packages of trades, each of which meets one or more criteria. For example, a trade package can be required to: reduce the variance by a minimum amount; require less than a maximum amount of trades; require less than a maximum amount of capital; and/or the like. Furthermore, the user 12 can subsequently request re-generation and/or modification of a trade package by specifying one or more additional criteria (e.g., requiring/excluding a particular trade), modifying one or more objectives (e.g., making an objective less/more important), and/or the like.

In an embodiment, proposed trade data 42A, 42B, which can be generated by the user 12 and/or the computer system 20, can include data corresponding to trades not currently available. For example, the computer system 20 can analyze the variance between the current portfolio and the target portfolio and determine which types of bond purchases, sales, swaps, will best reduce the variance, e.g., bonds having a combination of attributes that will most efficiently reduce the variance. Data regarding such trades can be included in the proposed trade data 42A, 42B, which the user 12 can use to quickly evaluate and execute a trade when it becomes available on the market. In an embodiment, the proposed trade data 42A, 42B can be generated and evaluated apart from a portfolio. In this case, the user 12 can decide to later add proposed trade data 42A, 42B to a portfolio after such evaluation. Regardless, some or all of the proposed trade data 42A, 42B can be stored for later reference, e.g., as portfolio data 34 or data stored separately from the portfolio data 34. In this manner, the user 12 can evaluate trade ideas, create and save potential trades, evaluate trades outside a portfolio and/or within a portfolio, split a trade (swap) and re-combine the trade (e.g., by adding and/or subtracting bonds), and/or the like. Such evaluation can be performed in the context of bonds currently available for purchase, bonds currently available for sale, generic bonds of a certain structure, and/or the like.

In an embodiment, the computer system 20 uses an objective matrix to evaluate bond offer data 40A for proposed purchases, sales, swaps, and/or the like, of bonds. Furthermore, the computer system 20 can provide an indication of how much better/worse the purchase/sale of one bond is than another bond being evaluated. To this extent, the computer system 20 can generate bond data regarding a set of attributes of each bond. The bond attributes can include: coupon, callability, schedule, maturity, sector, rating, bond owner, bond issuer, state, tax status, and/or the like. In an embodiment, the computer system 20 represents the bond attributes in n-space (e.g., a dimension for each attribute).

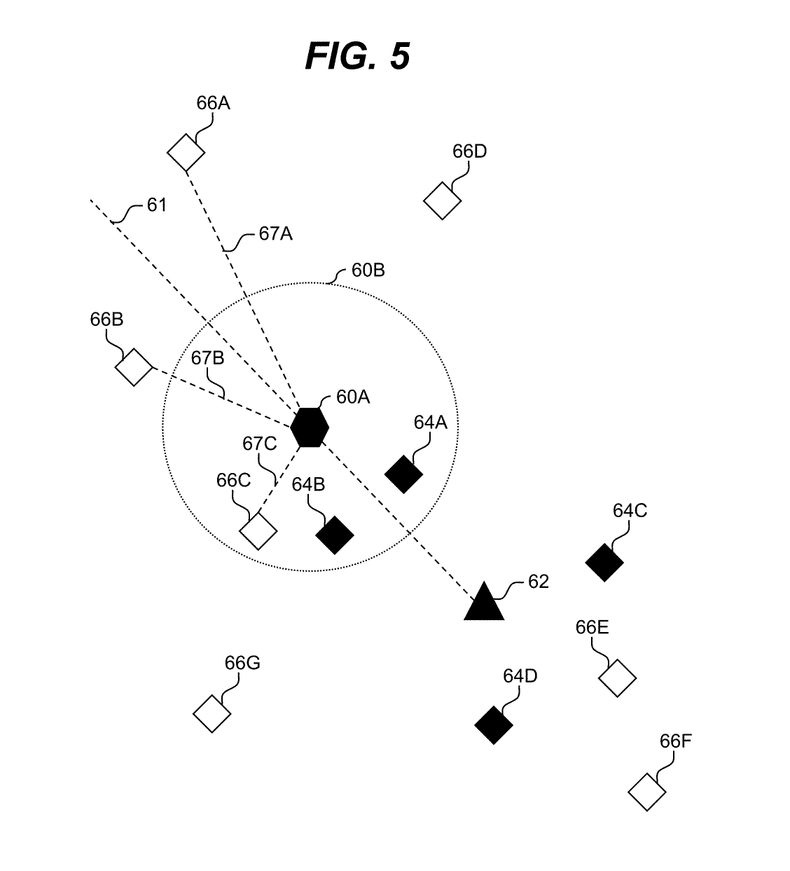

FIG. 5 shows an illustrative graph of various bonds and a bond portfolio according to an embodiment. In this case, the graph is shown in two dimensions. However, it is understood that the graph can be conceptually made in any number of n-dimensions. In an illustrative embodiment, the graph has five or more dimensions. In a more particular illustrative embodiment, the graph has twenty-five or more dimensions.

Regardless, each dimension of the graph can correspond to a value (which can be numeric or non-numeric) assigned for a particular attribute of the corresponding bond or a combination of a group of related attributes of the corresponding bond. Additionally, the graph can include a location for a target portfolio 60A, a target acceptable variance 60B (which can be defined in objective data as an acceptable value range for each attribute) indicated for the target portfolio 60A, and a plot of a current portfolio 62. The plot for the target portfolio 60A can be generated from the objective data 34B for the portfolio, while the plot for the current portfolio 62 can be generated by combining the current bond data 34A for the current portfolio. Additionally, a plot for each current bond 64A-64D making up the current portfolio 62 and a plot for each of various available bonds 66A-66G, which can be considered for purchase and addition to the current portfolio 62, are included in the graph.

The computer system 20 can use a vector to describe how far and in which direction a particular bond 64A-64D, 66A-66G and/or the current portfolio 62 are from the target portfolio 60A. In an embodiment, the computer system 20 can calculate the current portfolio 62 as a sum of these vectors. The computer system 20 can calculate the spatial distance between the current portfolio 62 and the target portfolio 60A and scale them by other factors. Illustrative scaling factors can include, for example, a relative importance among attributes, a concentration contribution of a bond to the portfolio, vector normalization to account for different attribute scales, and/or the like. The computer system 20 can rank recommendations for purchasing available bonds 66A-66G based on the available bonds 66A-66G that most efficiently move the current portfolio 62 toward the target portfolio 60A. Likewise, the computer system 20 can recommend current bonds 64A-64D to sell based on the lowest matches with the target portfolio 60A preferences.

For example, in order to efficiently move the current portfolio 62 closer to the target portfolio 60A, a set of bond purchases, sales, and/or swaps should move the current portfolio 62 along the vector 61. To evaluate the suitability of a particular available bond 66A-66G, the computer system 20 can calculate a corresponding vector (only vectors 67A-67C for the available bonds 66A-66C are shown for clarity) between the available bond 66A-66G and the target portfolio 60A. The available bond 66A-66G having a vector 67A-67C of an opposite sign of the vector 61 and for which the absolute values are closest, is the available bond 66A-66G, which will move the current portfolio 62 most efficiently toward the target portfolio 60A. As illustrated, despite the available bond 66C being closer aligned to the target portfolio 60A, a purchase of available bond 66A or available bond 66B will move the current portfolio 62 in the desired direction more efficiently.

The computer system 20 can calculate a contribution of how a particular trade moves the current portfolio 62 using vector math. In particular, the computer system 20 can determine how an available bond 66A-66G will move the current portfolio 62 by subtracting the corresponding bond vector for the available bond 66A-66G from the current portfolio 62. Subsequently, the computer system 20 can rank the various available bonds 66A-66G based on the resulting distance between the current portfolio 62 and the target portfolio 60A should the available bond 66A-66G be added to the current portfolio 62. The computer system 20 also can perform a similar evaluation for sales of the current bonds 64A-64D from the current portfolio 62 as well as swaps and combinations of purchases/sales of bonds.

In an embodiment, the computer system 20 can perform N-space math using a set of matrices. In this case, the N-space bond and portfolio representation, vectors, and matrix manipulation of vectors, enable the computer system 20 to provide a flexible and fast decision solution for determining bond and portfolio optimality, which can assist the user 12 in executing transactions in real time during the trading day. In particular, by utilizing the addition and subtraction of N-space vectors in matrices, the computer system 20 can make fast decisions regarding hundreds of bonds, without needing to evaluate one bond at a time.

As described herein, to provide an efficient evaluation of potential trades, the computer system 20 can model as a vector each of: an individual bond, a portfolio including multiple bonds, a hypothetical target portfolio, and a difference between a current portfolio and the corresponding target portfolio. The computer system 20 can further employ one or more scalars, which can allow the computer system 20 to account for relative contributions of bonds in a portfolio, account for relative importance of different attributes, perform normalization of vectors, and/or the like. For example, in a given portfolio including multiple types of bonds, each type of bond will represent a corresponding percentage of the entire portfolio (e.g., based on a value of the holdings of each type of bond). The contribution scalar accommodates such information into the evaluation process. Similarly, a user may identify various attributes of bonds and/or the overall portfolio as being more or less important than other attributes. In this case, the computer system 20 can use an importance scalar to increase/reduce the effect that variations from the desired attributes have on an overall evaluation of the desirability of adding/removing a bond to/from the portfolio.

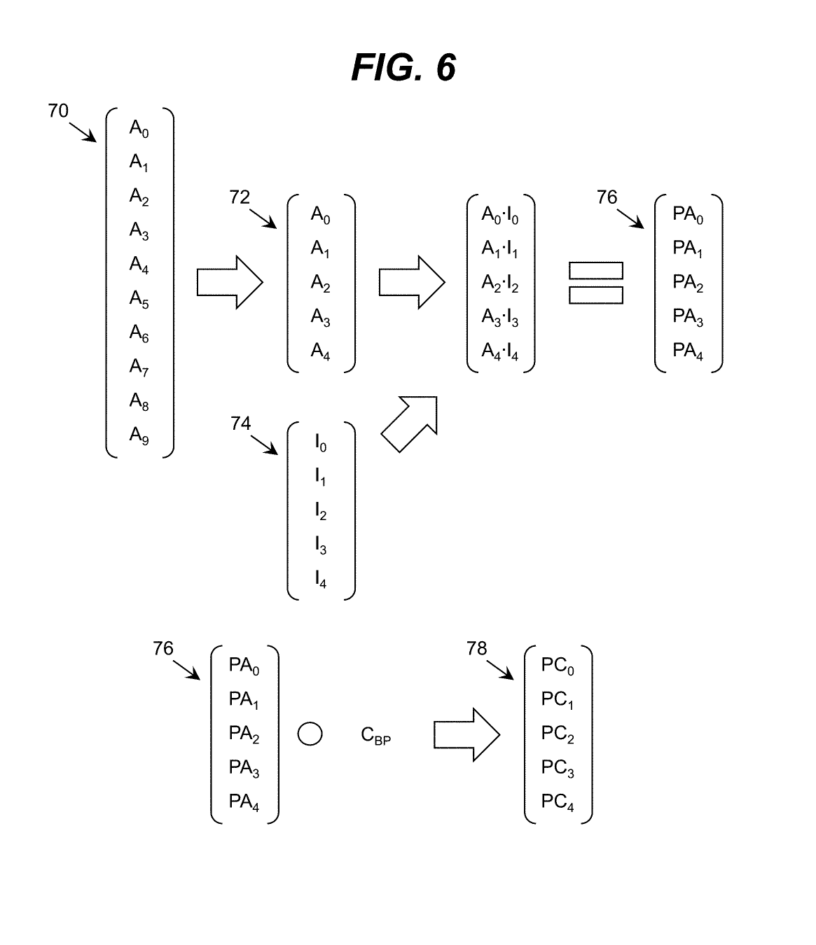

FIG. 6 shows various illustrative vectors and vector calculations that can be performed by the computer system 20 according to an embodiment. In FIG. 6, a raw bond vector 70 is shown for a bond having ten attributes, A₀ through A₉. The raw bond vector 70 can include all attributes of the corresponding bond that may be considered in evaluating the bond for adding to or removing from a portfolio. However, the raw bond vector 70 is a representation of the bond that is independent from any portfolio. The computer system 20 can store the raw bond vector 70 as bond data 40B (FIG. 2) for the corresponding bond. The bond data 40B can include additional information regarding the bond, which does not affect a decision on whether or not the bond should be included in a given portfolio and therefore is not necessary to include in the raw bond vector 70, such as a bond name, a bond symbol, and/or the like.

When considering a given bond in conjunction with a portfolio, the computer system 20 can perform one or more manipulations to the raw bond vector 70. For example, the computer system 20 can generate a portfolio relevant bond vector 72 which includes only the attributes (e.g., attributes A₀ to A₄ in this example) that are relevant in considering an effect that the bond will exert on the portfolio. In particular, various attributes (e.g., attributes A₅ to A₅ in this example) may not be important for a given portfolio and therefore can be ignored when considering the bond in conjunction with the portfolio. Additionally, the relevant attributes may be more or less important than other relevant attributes. To this extent, the computer system 20 can create an importance scaling vector 74 for the particular portfolio. The importance scaling vector 74 can be used to generate a portfolio attribute vector 76, e.g., by multiplying each attribute value in the portfolio relevant bond vector 72 with a corresponding importance scaling factor in the importance scaling vector 74.

The portfolio attribute vector 76 comprises a weighted representation of relevant bond attributes with respect to the corresponding portfolio. The computer system 20 can store the portfolio attribute vector 76 as bond data 34A (FIG. 2) for the corresponding portfolio 34 (FIG. 2). The computer system 20 can determine a contribution scalar C_{BP} for the corresponding bond in the portfolio. The contribution scalar C_{BP} can comprise, for example, a percentage of the total holdings in a portfolio corresponding to the bond. The percentage of total holdings can be calculated using any solution, such as a percentage of the overall value of the portfolio that corresponds to the holdings of the particular bond (e.g., the market value of the particular bond). Regardless, the computer system 20 can multiply the portfolio attribute vector 76 by the contribution scalar C_{BP} to create a portfolio contribution vector 78, which represents the contribution to the portfolio made by the bond for each relevant attribute. The computer system 20 can store the portfolio contribution vector 78 for each bond in a portfolio as portfolio data 34 (FIG. 2). The stored portfolio contribution vector 78 can be utilized to speed calculations for possible changes to the portfolio as described herein.

It is understood that the vectors shown and described in conjunction with FIG. 6 are only illustrative. To this extent, the particular vector manipulations and/or calculations can be modified in numerous ways. For example, rather than creating a portfolio relevant bond vector 72, the scaling vector 74 can include an entry for each attribute in the raw bond vector 70, with the entries in the importance scaling vector 74 corresponding to attributes not relevant to the portfolio set to zero. Such an embodiment can be useful when the particular attributes that may be considered relevant for a portfolio can change. Additionally, rather than storing the portfolio attribute vector 76 as bond data 34A, the computer system 20 can multiply the portfolio relevant bond vector 72 (or the raw bond vector 70) by the contribution scalar C_{BP} and store the resulting vector as bond data 34A. Furthermore, the computer system 20 can first multiply the portfolio relevant bond vector 72 by the contribution scalar C_{BP} and then multiply each entry by the corresponding entry in the importance scaling vector 74 to generate the portfolio contribution vector 78.

One or more attributes in the portfolio relevant bond vector 72 may be blank. For example, an attribute may correspond to a rating from a rating agency, and a bond may not have such a rating from any rating agency. In this case, the bond does not contribute to the corresponding attribute of a portfolio. To accommodate this, the contribution scalar C_{BP} can be calculated on a per attribute basis for each attribute in the portfolio relevant bond vector 72. As a result, instead of a single contribution scalar C_{BP} for a given bond, each portfolio relevant attribute for each bond could have a contribution scalar C_{BP}, which can be used to adjust the corresponding value of the attribute similar to the importance scaling vector 74. Similarly, a bond could have a default contribution scalar C_{BP}, which is utilized for each attribute that cannot be blank, while each attribute that can be blank has its own contribution scalar C_{BP}. The discussion herein primarily considers the situation where each bond has a single contribution scalar C_{BP} for clarity. However, it is understood that considerations and calculations described herein can be readily extended to each bond having multiple contribution scalars C_{BP}.

Each attribute in the raw bond vector 70 can have a corresponding range of acceptable values. For example, a duration attribute can have a range of 0 to 15 while a maturity can have a range of 0 to 100. In an embodiment, the different ranges of a values in a vector are normalized, so that each range is identical. In this manner, variations in values having a relatively large range will not outweigh variations in values having a relatively small range. In an embodiment, the computer system 20 can create a normalization vector, which is used to normalize the portfolio relevant bond vector 72, the raw bond vector 70, and/or the like. In a further embodiment, the importance scaling vector 74 can be used to both normalize and adjust the relative importance of the values in the resulting portfolio attribute vector 76.

Additionally, one or more attributes can be non-numeric attributes. To this extent, some non-numeric attributes can be expressed as yes or no values. In this case, the computer system 20 can convert the values to Boolean values (e.g., zero or one). For example, a bond may be classified in one of various sectors. In this case, the computer system 20 can generate a sector value for the attribute based on whether the bond is in a target sector (true) or not in the target sector (false). In another embodiment, the computer system 20 can include a unique Boolean attribute value for each of the possible sectors. Similarly, bond ratings (e.g., as supplied by Moody's, S&P, Fitch, and/or the like) are typically non-numeric. In an embodiment, the computer system 20 can use a mapping of a rating from an agency to a numeric equivalent. For example, highly rated bonds can be assigned a low numeric equivalent, while lower rated bonds can be assigned a high numeric equivalent. A bond may be rated by more than one ratings agency. Additionally, the ratings can have different numeric equivalents. In this case, the computer system 20 can use any solution for assigning a single numeric rating for the bond including, for example, using the highest/lowest rating, averaging the ratings, and/or the like.

As expressed by the portfolio contribution vector 78, each bond in a portfolio, or being considered for a portfolio, exerts a pull effect on the average of the portfolio for each of the attributes in the portfolio contribution vector 78 (PC₀ . . . PC₄). The effect has a directionality corresponding to number of attributes in the portfolio contribution vector 78 and a magnitude, which is based on the contribution scalar C_{BP} and a difference between the corresponding attribute values of the portfolio and the portfolio contribution vector 78.

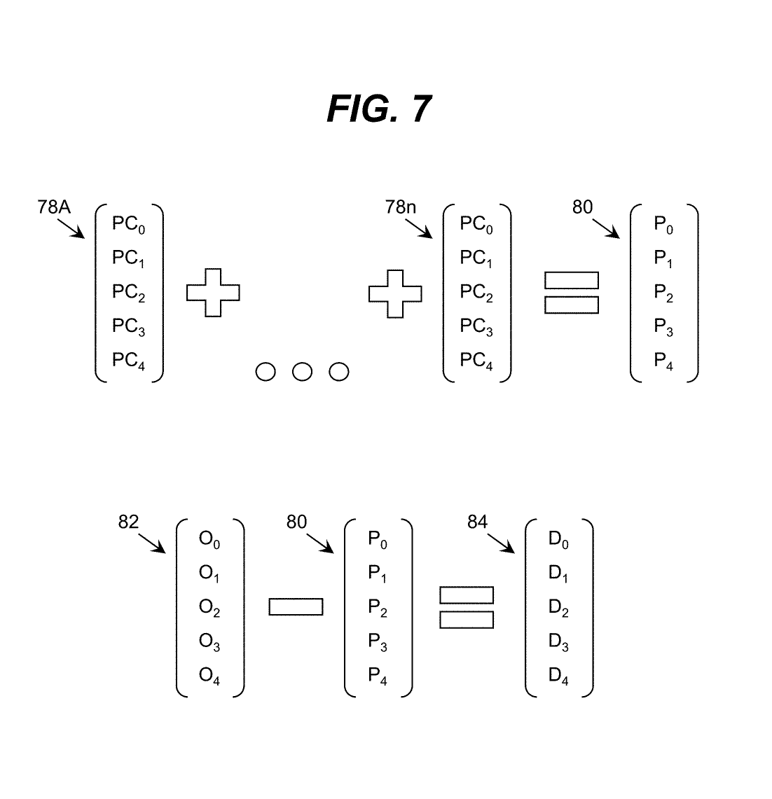

As illustrated in FIG. 7, the computer system 20 can create a portfolio vector 80 for a given portfolio by summing the portfolio contribution vectors 78A-78n for each of the n bonds in the portfolio. As a result, the portfolio vector 80 will describe the average attribute for each of the relevant attributes for the portfolio. Additionally, the computer system 20 can generate an optimal vector 82 for the portfolio based on user preferences for the portfolio. The optimal vector 82 comprises a vector with the target value (e.g., O₀ . . . O₄) for each of the attributes relevant for the portfolio. By subtracting the portfolio vector 80 from the optimal portfolio vector 82, the computer system 20 can generate a difference vector 84, which represents how different the current portfolio (as represented by the portfolio vector 80) is from the user-defined optimal portfolio (as expressed by the optimal vector 82). Using the difference vector 84, the computer system 20 can calculate and store a nominal difference between the optimal vector 82 and the portfolio vector 80, e.g., by summing the squares of the values (D₀ . . . D₄) in the difference vector 84 and calculating the square root.

The computer system 20 can store one or more of the vectors 80, 82, 84 as portfolio data 34 (FIG. 1) for the corresponding portfolio. Additionally, the computer system 20 can generate and store additional information regarding the portfolio. To this extent, in addition to the optimal vector 82, one or more attributes relevant to the portfolio can have a corresponding tolerance for variation from the target value. The variation can be expressed, for example, as a +/−range. Additionally, the variation also can have a preference associated therewith. The preference can express a relative desire to be higher or lower than the target value. For example, a portfolio can have a target duration of 5.5, a tolerance of +/−0.5, and a 70% preference for the low side of the tolerance. In an embodiment, the computer system 20 can store the definition of the optimal portfolio as a series of target attribute values and related acceptable variations, such as {O₀, low value for O₀, highest value for O₀, low preference for O₀, high preference for O₀}, as portfolio data 34 using any solution.

In a more particular embodiment, the target attribute value can be expressed as an inner range, with one or more outer ranges. In this case, the computer system 20 can define a target attribute range and related acceptable variations, such as {low target value for O₀, high target value for O₀, lowest value for O₀, highest value for O₀, low preference for O₀, high preference for O₀}, which can be stored as portfolio data 34 using any solution. In another embodiment, the preference for each range can correspond to a target percentage of the portfolio. For example, a portfolio may specify a target percentage of the portfolio bonds having an attribute value in each of multiple ranges. As a more particular example, a portfolio may have a target of a certain mix of bonds having a short, medium, and long durations, each of which is defined by a corresponding range of values. The computer system 20 can use the tolerance and/or preference(s) expressed for a portfolio attribute to evaluate possible modifications to the portfolio as described herein.

The computer system 20 can evaluate the stated portfolio targets to ensure that the targets are mathematically consistent, and the goals can be concurrently met. For example, considering duration as an illustrative attribute, the user can define a target duration with a specified tolerance for the entire portfolio as well as multiple ranges and target percentages of the portfolio within each of the ranges. In this case, the computer system 20 can evaluate the minimum and maximum possible durations for a portfolio that meets the target percentages within each of the specified ranges and confirm that the target duration and tolerance for the entire portfolio are within these minimum and maximum possible durations. If not, the computer system 20 can present a warning to the user and enable the user to readjust one or more of the specified targets.

While the computer system 20 can consider all relevant attributes of adding or removing a bond to or from a portfolio, it is understood that embodiments can consider only a subset (i.e., one or more) of the relevant attributes with respect to adding or removing a bond to or from a portfolio. For example, a user may want to prioritize correcting one or more of the portfolio attributes without regard to how the newly added or removed bonds affect other attributes. In this case, the computer system 20 can restrict analysis of possible portfolio changes to only the subset of the relevant attributes.

Additionally, the computer system 20 can evaluate only a subset of the relevant attributes to limit the total number of bonds considered for addition to or removal from a portfolio. To this extent, bonds having one or more relevant attributes outside of a given range can be removed from consideration by the computer system 20 without analyzing the effects that the bond may have on all of the relevant attributes. For example, a portfolio may have a variation from a target value that is at the edge of a defined tolerance range. In this case, the computer system 20 can remove from consideration any bond that would result in moving the target value outside of the tolerance range. However, it is understood that this is only illustrative, and such a bond could be considered for addition to or removal from the portfolio as part of a transaction involving multiple bonds.

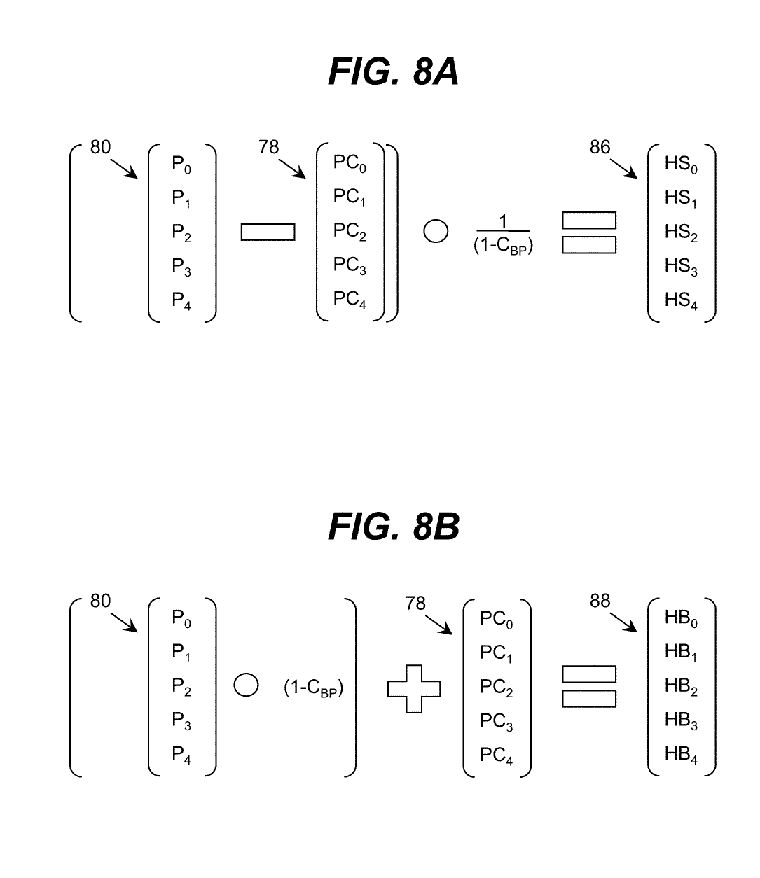

Using the vectors described herein, the computer system 20 can evaluate transactions involving the portfolio. For example, as illustrated in FIG. 8A, the computer system 20 can evaluate the removal of a bond having a portfolio contribution vector 78 from a portfolio having a portfolio vector 80. In this case, the computer system 20 can first subtract the portfolio contribution vector 78 for the bond from the portfolio vector 80. Subsequently, the computer system 20 can re-scale the contribution scalar for each remaining bond in the portfolio. A removal scale factor for a given bond being considered for removal (or being removed) from a portfolio is calculated by dividing one by one minus the contribution scalar C_{BP} for the bond in the portfolio. Since the contribution of each bond in the portfolio is scaled by the same removal scale factor, the computer system 20 can multiply the portfolio vector without the portfolio contribution vector 78 for the bond by the removal scale factor to generate the hypothetical sale vector 86 for the portfolio.

In an embodiment, the computer system 20 can pre-calculate an effect of removing each bond from a portfolio and store data relating to the effect as portfolio data 34. Such data can include, for example, the resulting hypothetical sale vector 86, the removal scale factor, and/or the like. When a bond is removed from a portfolio, the hypothetical sale vector 86 becomes the portfolio vector 80 for the modified portfolio. Additionally, the computer system 20 can re-scale the stored contribution scalar C_{BP} for each remaining bond in the portfolio by, for example, multiplying each contribution scalar C_{BP} by the removal scale factor for the removed bond. Additionally, the computer system 20 can update additional portfolio data 34, such as a stored portfolio contribution vector 78 for each bond, a stored hypothetical sale vector 86 for each bond, a stored difference vector 84, and/or the like, based on the removed bond.

To evaluate an addition of a bond to a portfolio, the computer system 20 can calculate a portfolio contribution vector 78 for the bond after its addition using a hypothetical revised portfolio as described herein in conjunction with FIG. 6. To this extent, the computer system 20 can calculate a contribution scalar C_{BP} for the bond in the hypothetical revised portfolio. Additionally, as shown in FIG. 8B, the computer system 20 can re-scale the current portfolio vector 80 to account for the adjusted contributions of each bond currently in the portfolio using an addition scale factor for the bond being considered for addition (or being added to) the portfolio. The addition scale factor can be calculated as one minus the contribution scalar C_{BP} for the bond. Since the contribution of each bond in the portfolio is scaled by the same addition scale factor, The computer system 20 can multiply the current portfolio vector 80 by the addition scale factor and subsequently add the portfolio contribution vector 78 for the bond being evaluated for addition to the portfolio to create a hypothetical buy vector 88. The resulting hypothetical buy vector 88 represents a hypothetical portfolio with the bond added.

When a bond is added to portfolio, the hypothetical buy vector 88 becomes the portfolio vector 80 for the modified portfolio. Additionally, the computer system 20 can re-scale the stored contribution scalar C_{BP} for each remaining bond in the portfolio by, for example, multiplying each contribution scalar C_{BP} by the addition scale factor for the added bond. Additionally, the computer system 20 can update additional portfolio data 34, such as a stored portfolio contribution vector 78 for each bond, a stored hypothetical sale vector 86 for each bond, a stored difference vector 84, and/or the like, based on the added bond.

In an embodiment, the computer system 20 can consider more complex transactions, such as a sale including multiple bonds, a purchase including multiple bonds, and/or a transaction including the sale of one or more bonds and the purchase of one or more bonds. For a sale including multiple bonds, the computer system 20 can calculate the removal scale factor by adding the contribution scalars C_{BP} for each of the bonds being sold, subtracting the sum from one, and finding the reciprocal. Similarly, the computer system 20 can calculate a combined portfolio contribution vector 78 for the bonds being sold by summing the portfolio contribution vectors 78 for each of the bonds. Subsequently, the process can proceed as described in conjunction with FIG. 8A, with the combined portfolio contribution vector 78 being subtracted from the portfolio vector 80 and the result being multiplied by the removal scale factor.

For a purchase including multiple bonds, the computer system 20 can calculate the addition scale factor by adding the contribution scalars C_{BP} for each of the bonds being purchased and subtracting the sum from one. Note that the contribution scalar C_{BP} for each of the bonds being purchased must be computed assuming the portfolio includes all of the bonds being purchased. Similarly, the computer system 20 can calculate a combined portfolio contribution vector 78 for the bonds being purchased by summing the portfolio contribution vectors 78 for each of the bonds. Subsequently, the process can proceed as described in conjunction with FIG. 8B, with the portfolio vector 80 being multiplied by the addition scale factor and the result being added to the combined portfolio contribution vector 78.

For a transaction including one or more bonds being sold and one or more bonds being purchased, the computer system 20 can first calculate the sale portfolio vector (e.g., the hypothetical sale vector 86) based on the bond(s) being sold, and subsequently calculate the resulting portfolio vector for the transaction by calculating a buy portfolio vector (e.g., the hypothetical buy vector 88) using the sale portfolio vector as the portfolio vector. In this case, when determining the contribution scalar(s) C_{BP} for each bond being purchased, the computer system 20 must use the portfolio as it would appear after the sale and including all bonds being purchased.

Alternatively, the computer system 20 can determine whether the net of a transaction is equivalent to a sale or purchase, and update the portfolio vector 80 accordingly. For example, the computer system 20 can determine a combined contribution scalar C_{BP} using the contribution scalar C_{BP} for each bond being sold. The computer system 20 can determine a contribution scalar C_{BP} for each of the bonds being purchased based on the contribution scalar C_{BP} for one or more of the bonds being sold or currently in the portfolio, and/or one or more attributes of the portfolio. For example, when the contribution scalar C_{BP} is calculated as a percent of the total cost of the bonds in the portfolio, the computer system 20 can use the total cost of the current portfolio and calculate a contribution scalar C_{BP} for each of the bonds being purchased based on the cost of the bond. Alternatively, the computer system 20 can use a ratio between the cost of a bond in the current portfolio and its contribution scalar C_{BP} to derive the contribution scalar C_{BP} for each bond being purchased using the corresponding cost of the bond. Regardless, using the contribution scalars C_{BP} for the bonds being purchased, the computer system 20 can create a portfolio contribution vector 78 for each bond being purchased, and sum the portfolio contribution vectors 78 and contribution scalars C_{BP} to create a combined portfolio contribution vector 78 and a combined contribution scalar C_{BP} for the bonds being purchased as part of the transaction.

The computer system 20 can compare the combined contribution scalars C_{BP} for the sale and purchase, and proceed to treat the transaction as a sale or purchase based on the larger combined contribution scalar C_{BP}. In this case, the computer system 20 can subtract the smaller combined contribution scalar C_{BP} from the larger combined contribution scalar C_{BP} to create a transaction contribution scalar used for the transaction. Additionally, the computer system 20 can create a transaction portfolio contribution vector 78 by subtracting the combined portfolio contribution vector for the sale from the combined portfolio contribution vector for the purchase. When the combined contribution scalars C_{BP} are the same, the computer system 20 can proceed according to either a sale or a purchase.

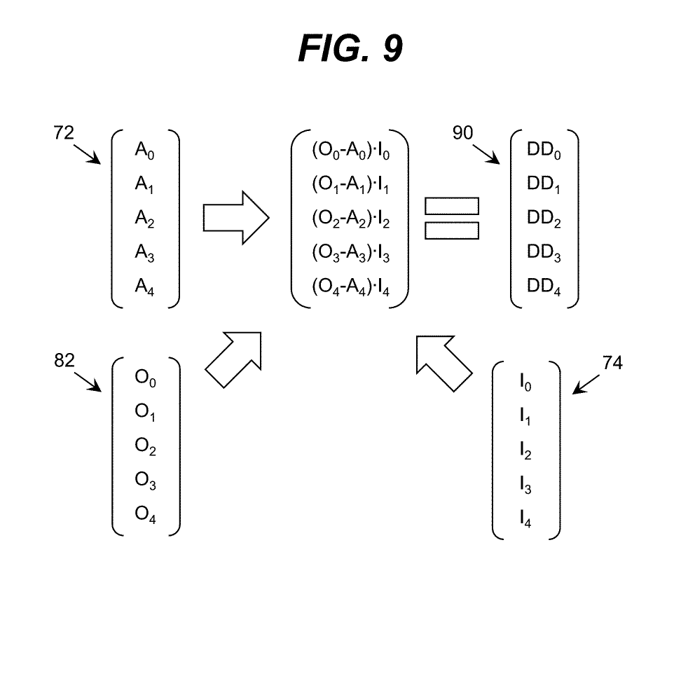

As described herein, the computer system 20 can evaluate only a subset of the relevant attributes to limit the total number of bonds considered for addition to or removal from a portfolio. In an embodiment, the computer system 20 can generate and store a distance derivative vector for a bond with respect to an optimal portfolio. To this extent, as shown in FIG. 9, the computer system 20 can generate a distance derivative vector 99 by subtracting the portfolio relevant bond vector 72 for the bond from the optimal vector 82 for the portfolio. In a more particular embodiment, the distance derivative vector is weighted by the importance of each relevant attribute and/or normalized. In this case, the computer system 20 can further multiply each attribute in the distance derivative vector by a corresponding importance (e.g., as stored in the importance scaling vector 74) to generate a final distance derivative vector 90. The distance derivative vector 90 can be stored as portfolio data 34 (FIG. 1) for the portfolio and associated with the particular bond.

In this case, each entry in the distance derivative vector 90 represents how closely a bond is aligned with the optimal portfolio for a particular portfolio. For each attribute, a lower value in the distance derivative vector 90 represents better alignment between the bond and the optimal portfolio. By weighing the raw distance according to importance, the computer system 20 can better identify a more urgent problem to solve by considering both distance and importance of the attribute. As described herein, the attribute values can be normalized to prevent attributes having significantly larger values than other attributes to adversely impact the determination.

In an embodiment, to allow the computer system 20 to efficiently evaluate bond transactions, the computer system 20 can calculate and store a distance derivative vector 90 for each bond in a portfolio (e.g., as bond data 34A (FIG. 2) for the portfolio). Additionally, when the computer system 20 obtains bond offer data 40A (FIGS. 3A-3B), the computer system can generate and store a distance derivative vector 90 for each combination of bond identified in the bond offer data 40A and portfolio 34. Additionally, the computer system 20 can calculate and store data representing a distance between the bond and the optimal portfolio. For example, using the distance derivative vector 84, the computer system 20 can calculate and store an importance-weighted distance between the optimal vector 82 and the portfolio relevant bond vector 72, e.g., by summing the squares of the values (DD₀ . . . DD₄) in the distance derivative vector 90 and calculating the square root. Similarly, when the distance derivative vector 90 is not weighted, or prior to accounting for the weights, the computer system 20 can calculate a nominal distance between the optimal vector 82 and the portfolio relevant bond vector 72. The distance(s) also can be stored as bond data 34A for the portfolio.

In an embodiment, the computer system 20 can calculate an optimality score for a particular bond with respect to an optimal portfolio. For example, as discussed above, each relevant attribute of the portfolio can have a specified target value/range, a larger tolerance range, preferences for low/high misses in the tolerance range, and/or the like. The computer system 20 can assign optimality points to each attribute of the bond based on its meeting the stated criteria. For example, in an embodiment, if the bond attribute is within the specified larger tolerance range, the computer system 20 can assign an optimal value to the bond attribute indicating it meets the specified criteria. Alternatively, when a bond attribute misses the target value/range, but is within the larger tolerance range, the computer system 20 can assign a partial optimal value to the bond attribute. Such a partial optimal value can be determined using any solution, such as the preference for low/high misses in the tolerance range and whether the bond attribute is low or high. For example, the computer system 20 can calculate the partial optimal value by multiplying the optimal value by the preference for the corresponding tolerance range.

Regardless, relevant attributes for a portfolio also can have a relative importance to other attributes of the portfolio. To this extent, the computer system 20 can account for the relative importance of the attributes when calculating the optimal value for each attribute of the bond. In an embodiment, the computer system 20 can multiply the optimal value for each attribute by the corresponding relative importance for the attribute (e.g., as indicated in the importance scaling vector 74 (FIG. 6). Once the computer system 20 has calculated an optimal value for each attribute of the bond, the computer system 20 can sum the optimal values to create the optimality score for the bond with respect to the optimal portfolio.

It is understood that the computer system 20 can calculate an optimality score for a bond using any of various alternative approaches to the approach described herein. In an embodiment, the approach described herein can be extended by one or more user-defined criteria. For example, a user may identify a group of attributes and a corresponding bonus for a bond that is within the target range of each attribute in the group of attributes. In this case, the computer system 20 can evaluate whether the user-defined criteria are met, and apply the corresponding bonus if necessary, to the bond's optimality score. Similarly, a user can define a penalty when a bond does not meet any of a group of attributes. The computer system 20 can allow a user to define any number of bonuses and/or penalties to be utilized in calculating an optimality score.

The computer system can utilize the data and vectors pre-calculated and stored to evaluate various potential trades for a portfolio. For example, the computer system 20 can limit bonds considered as part of a trade by identifying the best overall bond using any set of criteria. Illustrative criteria include the nominal distance to the optimal portfolio, the importance-weighted distance to the optimal portfolio, a distance and direction (weighted or un-weighted) for a particular attribute furthest from optimal in the current portfolio, and/or the like. Similarly, the computer system 20 can evaluate which portfolio of multiple portfolios being managed by a user is more urgent to be considered for sales/purchases based on the nominal distance to the optimal portfolio for each of the multiple portfolios under consideration.

The computer system 20 can utilize one or more settings or attributes to limit the total possible transactions to be evaluated. For example, the computer system 20 can set a maximum (as an absolute value or percentage) number of bonds in a portfolio that can be included in any proposed transaction. Furthermore, the computer system 20 can remove bonds from consideration using one or more attributes of the bond in comparison to the optimal portfolio. In an embodiment, the computer system 20 can use a combination of the optimality score for a bond and an evaluation of one or more attributes of the bond in comparison to the optimal portfolio to prioritize bonds in a portfolio for sale and/or available bonds for purchase. For example, bonds with an optimality score in the highest percentage of all bonds (e.g., highest 20%) and with more than a threshold number (e.g., 3) of attributes that meet the target criteria can be placed as a highest priority to purchase/lowest priority to sell. Bonds meeting fewer than the threshold number of attributes (e.g., 2 or 3) and with an optimality score in a middle region of all bonds (e.g., middle 40%) can be placed next in priority for purchase/higher in priority to sell. Bonds meeting only a minimal number of the target criteria (e.g., 1) and with an optimality score in the middle region of all bonds can be placed next in priority for purchase/sell. Finally, bonds meeting none of the target criteria and with an optimality score in the bottom region (e.g., bottom 20%) of all bonds can be placed in the lowest priority for purchase/highest priority to sell.

The computer system 20 can use other solutions for identifying and ranking bonds according to their suitability for a portfolio (whether in the portfolio or being considered for addition to the portfolio). For example, the computer system 20 can plot the optimality score versus the number of attributes that meet the target criteria for each bond under consideration. The further a bond is from the origin, the better the bond is suited for inclusion in the portfolio. Furthermore, the computer system 20 can evaluate bonds by sorting them according to each bond's contribution to the portfolio score, e.g., by sorting bonds according to the product of the bond's percentage of the portfolio and the bond's optimality score. When utilized to manage multiple portfolios, the computer system 20 can similarly generate a two dimensional plot showing a portfolio score for the portfolio versus a number of attributes of the portfolio that meet the specifications of the optimal portfolio, which can assist the user in identifying the portfolio(s) most in need of trading. Regardless, it is understood that these approaches are only illustrative, and the computer system 20 can utilize any of various selection and/or ranking criteria.

When evaluating transactions for a portfolio, the computer system 20 can use one or more criteria to quickly reduce the number of bonds to be considered as part of the transaction. Such criteria can be defined according to the objective(s) to be met with the transaction. For example, when a portfolio needs to increase an attribute value (e.g., duration) to be within a target range, any bond having an attribute value lower than the current attribute value for the portfolio can be removed from consideration for purchase, while any bond in the portfolio having an attribute value higher than the current attribute value for the portfolio can be removed from consideration for selling. However, it is understood that the computer system 20 can revise and relax such criteria when, for example, few or no transactions are initially identified that move the portfolio in a desired manner.

As described herein, the use of vectors to represent portfolios, bonds, etc., enables differences between attributes to be evaluated and considered in a manner similar to distances in a vector space. To this extent, in an embodiment, the computer system 20 can use Dijkstra's algorithm to identify and rank possible transactions for a portfolio. For example, the computer system 20 can use Dijkstra's algorithm to determine a most efficient bond trading path that moves the attributes of a portfolio closest to the attributes of its optimal portfolio. In this case, the length of the path between each bond and the optimal portfolio and the length of the path between each bond and the current portfolio used by Dijkstra's algorithm can be calculated using the distance along one or more of the attributes, which can be calculated as described herein.

To further assist the user in considering a trade, the computer system 20 can utilize additional bond data 40B (FIG. 2) for a given bond. For example, the computer system 20 can consider historical bond data, which can indicate whether the current market price for a particular bond is higher or lower than the price of the bond in previous trades. The computer system 20 can use any range of time or number of trades to evaluate the current market price for the bond. Additionally, the computer system 20 can compare the current market price for the bond with the current and/or recent prices of other similar bonds to evaluate whether the particular bond is priced high or low compared to other comparable bonds. For example, bond transactions for municipal bonds and taxable bonds have industry-mandated records, which can be utilized by the computer system 20. Furthermore, the computer system 20 can evaluate one or more attributes of bond offer data 40A (FIGS. 3A and 3B) to evaluate a desirability of purchasing the bond. For example, the computer system 20 can use one or more indications of liquidity, such as an issue size, a time from issue date, and/or the like, to evaluate the likely liquidity of the bond. Similarly, the computer system 20 can use historical bond offer data to evaluate how liquid a particular bond has been in the past.

Additionally, the computer system 20 can restrict proposed trades presented to the user, e.g., using one or more settings or attributes. For example, the computer system 20 may evaluate numerous trades that only result in a small improvement to the portfolio. In an embodiment, the computer system 20 can present only those trades that improve one or more attributes of the portfolio by a minimum amount for review by the user. The user can sort the trades by one or more attributes, such as fewest bonds involved, most significant improvement in a given attribute, smallest amount of remaining cash, and/or the like. Furthermore, the user can elect to view additional trades, which may have a smaller improvement on the portfolio, but may provide additional benefits.

While aspects of the invention have been described in conjunction with a single portfolio, it is understood that embodiments can be utilized by a user 12 concurrently managing tens to hundreds of portfolios including bonds. In an embodiment, the computer system 20 can process the portfolio data 34 for each such portfolio and rank the portfolios based on the distance from their objectives. In this case, the user 12 can first focus on trades for the portfolios that are currently furthest from the objectives defined in the portfolio data 34. For example, the computer system 20 can rank the portfolios by the extent of the variation, which can be calculated as described herein. In this manner, the computer system 20 can provide the user 12 with a solution for readily identifying and prioritizing those portfolio(s) most in need of change.

An embodiment of the computer system 20 can assist a user with managing numerous portfolios and evaluating possible transactions for the portfolios. To this extent, the computer system 20 can assist the user with identifying which portfolios are in most need of transactions to move the portfolio toward its optimal portfolio. For example, the computer system 20 can sort the portfolios according to the distance each portfolio is from the optimal portfolio. Once sorted, for one or more of the high priority portfolios, the computer system 20 can identify one or more bonds in the portfolio that are the best candidates for selling (e.g., to raise capital for purchasing better suited bonds). For example, the bonds in a portfolio can be sorted according to how closely each bond's attributes align with the optimal portfolio's attributes as described herein. In an embodiment, the computer system 20 can present only a subset of the bonds in a portfolio to the user for consideration, e.g., to limit the total number of bonds to a reasonable quantity for evaluation by the user.

Additionally, the computer system 20 can identify portfolios as candidates for a transaction based on one or more other attributes of the portfolio. For example, a portfolio may have an amount of un-invested cash that exceeds a threshold value (e.g., 15% of the portfolio). In this case, the computer system 20 can prioritize consideration of bond purchases for the portfolio that will reduce the amount of cash.

As described herein, a transaction for a portfolio may include the sale of one more bonds in a portfolio, the proceeds of which are subsequently used to purchase one or more bonds to add to the portfolio. As a result, a portfolio may temporarily be out of conformance while the transaction is completing. For example, the portfolio may temporarily have too much cash, or the portfolio may be temporarily significantly out of conformance with one or more target attributes. To avoid inadvertently identifying such a portfolio as requiring a transaction, the computer system 20 can store an indication that a transaction is in process for the portfolio and the portfolio analysis can be skipped for such a portfolio (or conducted based on how the portfolio will appear after the transaction has completed).

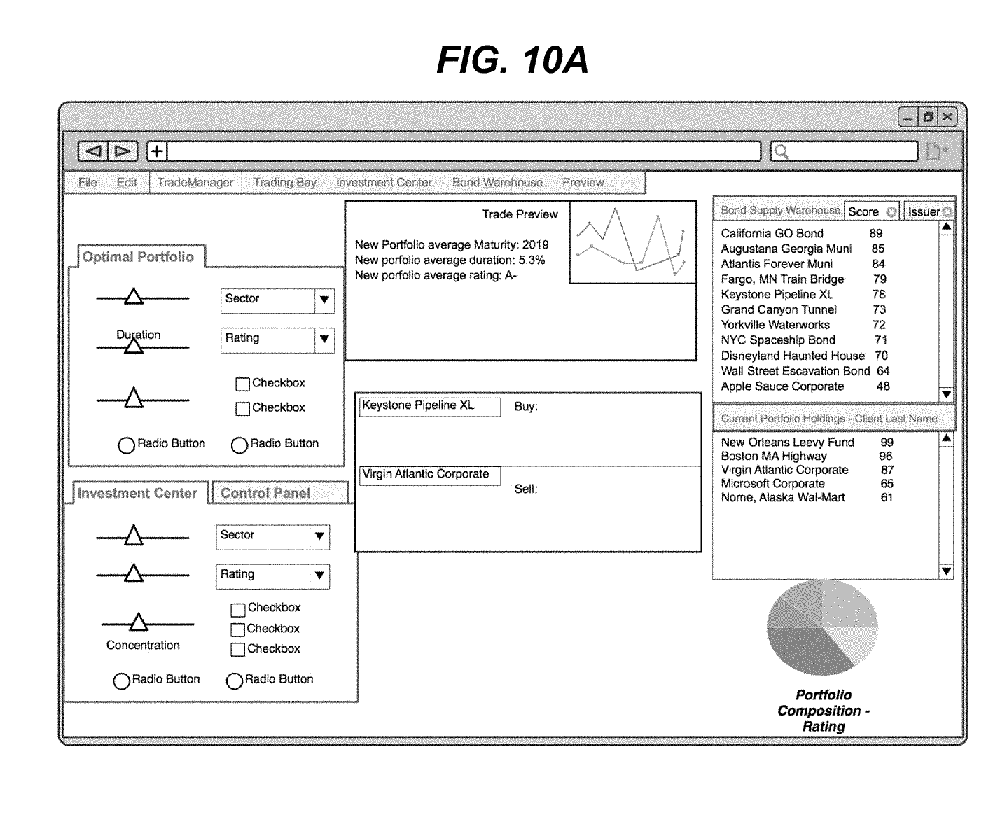

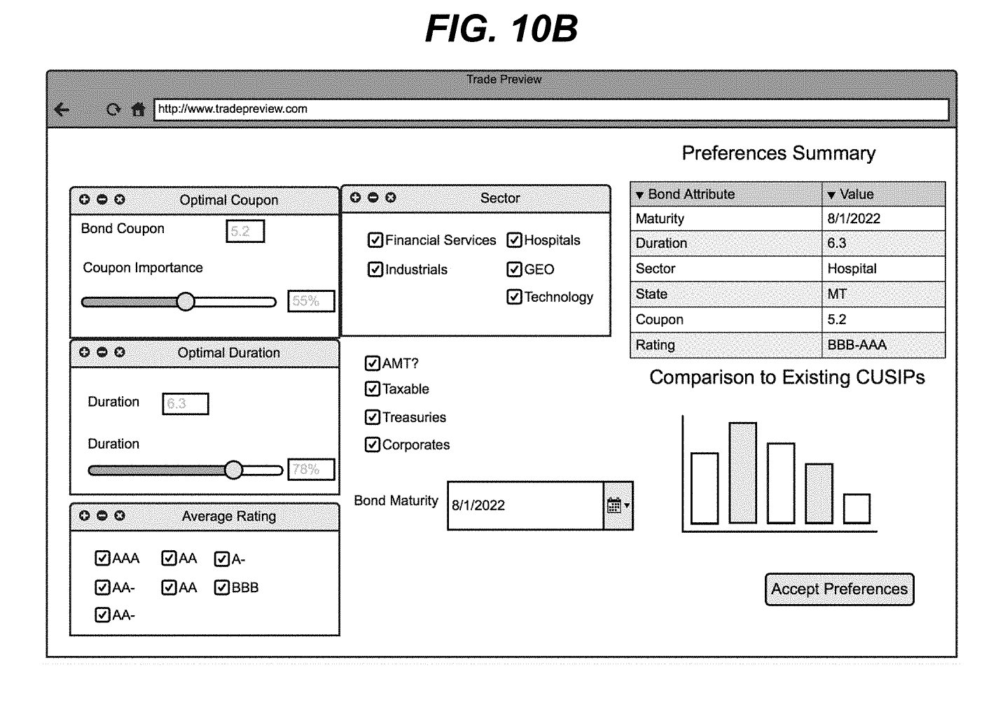

The computer system 20 can generate one or more graphical user interfaces to present the results of the analysis described herein to a user and enable the user to select various actions. To this extent, FIGS. 10A and 10B show illustrative interfaces, which can be generated by the computer system 20 and presented to a user according to an embodiment. For example, the interface shown in FIG. 10A can concurrently display one or more of the attributes defining an optimal portfolio associated with a current portfolio (e.g., within an optimal portfolio tab) as well as one or more of the attributes of the current portfolio (e.g., within an investment center tab), As illustrated, the interface can enable the user to selectively change one or more of the attributes of the optimal portfolio and/or the current portfolio being displayed via a set of user interface controls included in the interface. In an embodiment, when the user selects an attribute to be displayed for one of the optimal portfolio or the current portfolio, the computer system 20 can automatically change the display of the other of the optimal portfolio or the current portfolio. Alternatively, the attributes for each can be independently selected by the user. The computer system 20 can allow the user to select how the user desires the interface to function, e.g., via inclusion of one or more user interface controls that can be used by the user to change the functionality.

In an embodiment, one or more attributes of the optimal portfolio also can be selectively changed by the user in the interface. In this case, when the optimal portfolio is related to multiple investment portfolios, the computer system 20 can allow the user to select whether to apply the change to the other investment portfolios or create a new optimal portfolio for the current investment portfolios. Alternatively, the computer system 20 can restrict changes to an optimal portfolio via a different user interface.

Regardless, the interface also can enable the user to define a trade. For example, the interface is shown including a listing of bonds currently available for purchase. The interface displays a corresponding score for each bond (by which the bond listing is sorted), which reflects how well aligned the bond's attributes are with respect to the optimal portfolio. Additionally, the interface includes a listing of bonds within the current portfolio, which also includes the scores of each bond with respect to the optimal portfolio. As discussed herein, the computer system 20 can generate scores for the bonds based on all of the attributes of the optimal portfolio or a subset of the attributes of the optimal portfolio. For example, the computer system 20 can generate the bond scores based on the optimal portfolio attributes displayed in the interface.

As discussed herein, a change to a portfolio will frequently involve the sale of one or more bonds in the portfolio, which can finance the purchase of one or more available bonds. The computer system 20 can enable the user to identify one or more bonds to sell and/or buy using any solution. For example, the user can select an available bond and drag the bond into an area of the interface listing bond(s) to be bought as part of a trade. Similarly, the user can select a bond in the current portfolio can drag it to an area of the interface listing bond(s) to be sold as part of the trade. Regardless, in response to identification of a bond to sell/buy for the current portfolio, the computer system 20 can calculate the effect on the portfolio of the sale/purchase and generate a preview of one or more attributes of the portfolio assuming the trade is completed. For example, the computer system 20 can display the same subset of attributes displayed for the optimal portfolio and/or the current portfolio.

As previously discussed, the computer system 20 can generate an interface for allowing a user to view, define, modify, and/or the like, an optimal portfolio. For example, the computer system 20 can generate the interface shown in FIG. 10B, which allows the user to define various attributes of an optimal portfolio via various user interface controls presented therein. Additionally, the interface can present a summary of the current preferences defined for the optimal portfolio. Still further, the interface can present information relating to a number of currently available bonds that meet one or more of the preferences. For example, the interface can include a chart showing a percentage of and/or number of currently available bonds that meet the defined preference. In this manner, the computer system 20 can provide the user with some information regarding how easily each of the defined preferences can be met using data available regarding bonds currently being offered for purchase.

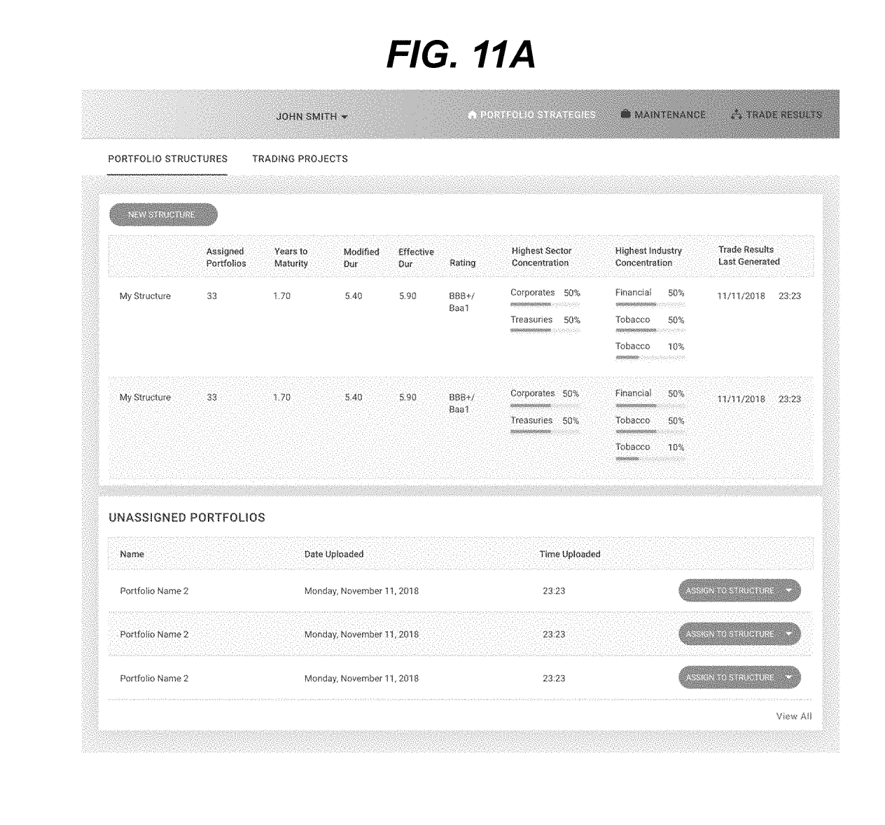

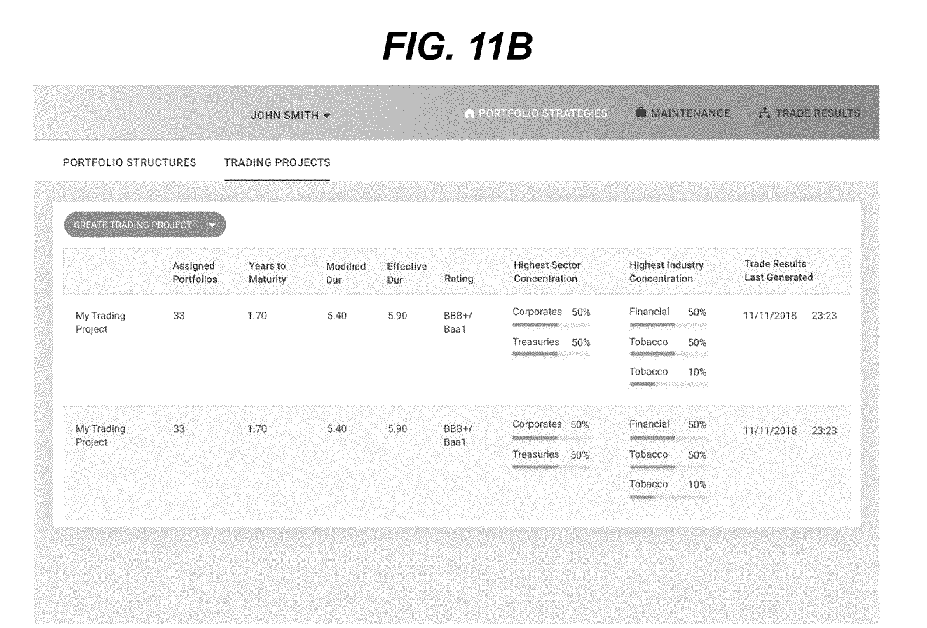

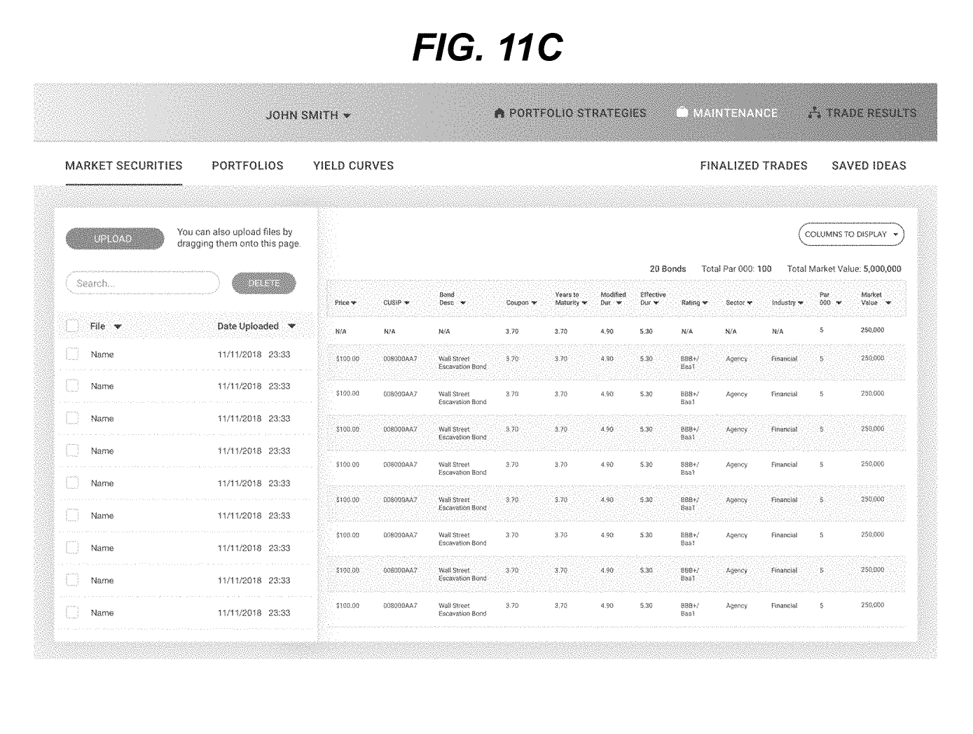

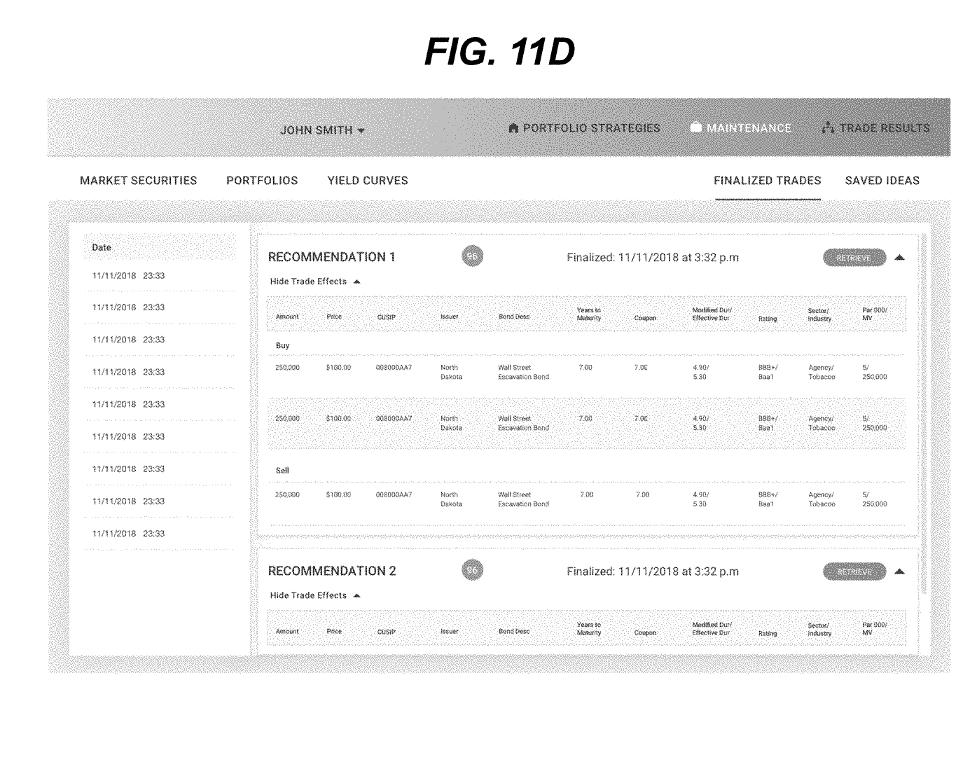

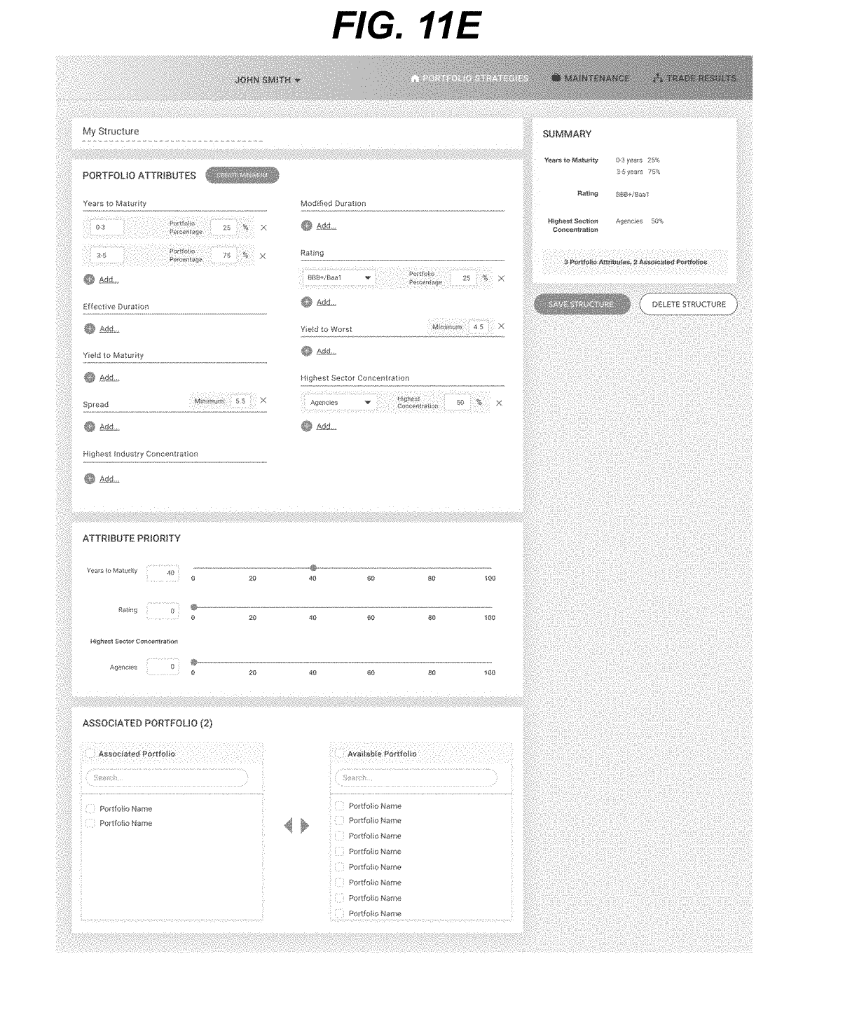

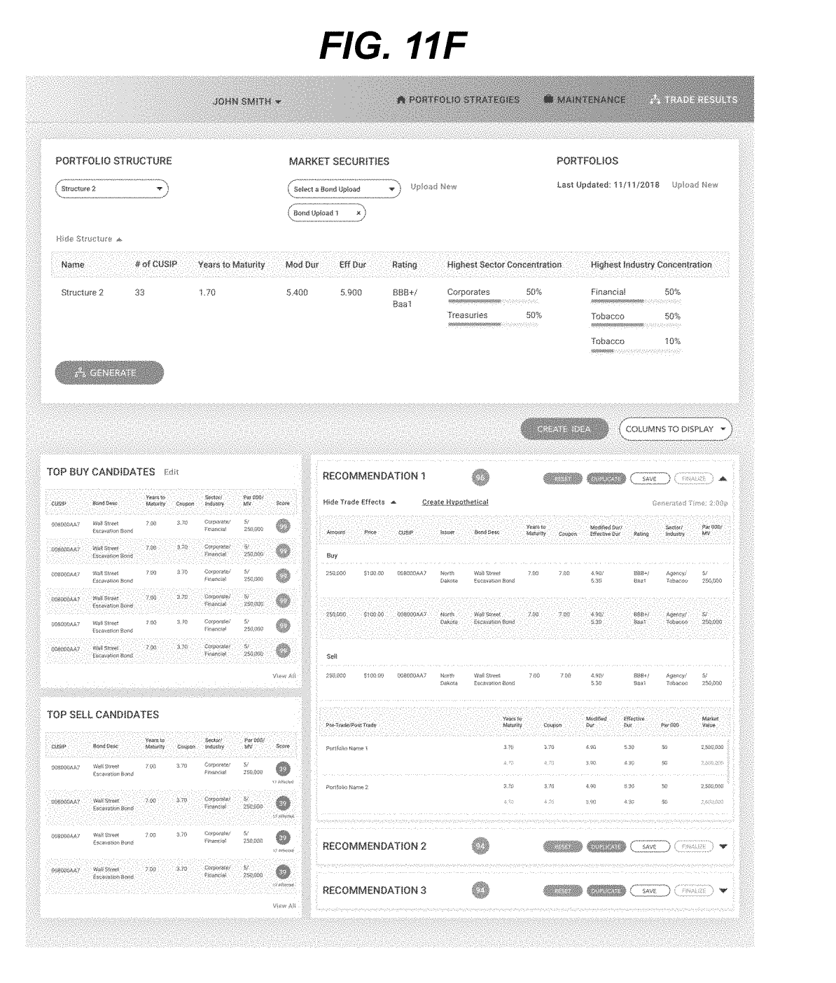

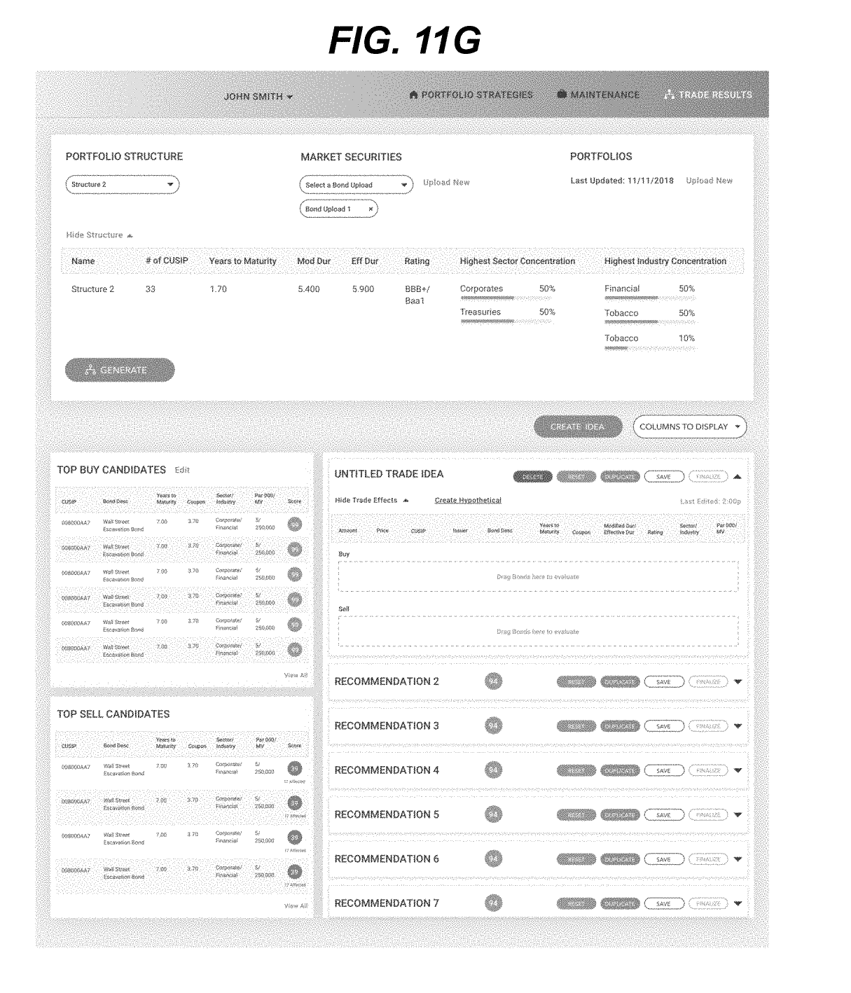

FIGS. 11A-11F show an illustrative series of user interfaces, which can be generated by the computer system 20, according to embodiments. As shown in FIG. 11A, the computer system 20 can generate an interface that allows a user to view and select from a list of portfolio structures (optimal portfolios). The interface can display various attributes of each defined portfolio structure, and allow the user to select one for editing and/or create a new portfolio structure. Additionally, the interface can display a list of current portfolios that are not associated with any portfolio structure. The interface can include one or more controls that enable the user to associate a portfolio with a portfolio structure, define a new portfolio structure for a portfolio, and/or the like. In an embodiment, in response to a request to create a new portfolio structure for an existing portfolio, the computer system 20 can use the attributes of the existing portfolio as default attributes for the portfolio structure.

FIG. 11B shows an illustrative interface that enables a user to view, create, edit, and/or the like, trading project(s). As illustrated, the interface can display a summary of various attributes of one or more trading projects currently defined. A trading project can be associated with one or more existing portfolios. Alternatively, a trading project can be associated with a portfolio structure. For a trading project associated with a portfolio structure, the computer system 20 can illustrate how a particular trade would affect the default attributes of the portfolio structure. For each associated existing portfolio, the computer system 20 can show how the trade would change one or more of the attributes of the existing portfolio with respect to an associated optimal portfolio.

FIG. 11C shows an illustrative interface that can enable a user to view various bonds available for purchase. Additionally, the interface can enable the user to identify data (e.g., stored in a file), which can be processed by the computer system 20 to update the bonds available for purchase (e.g., add additional bonds, remove bonds sold, and/or the like). As illustrated, the interface can include various attributes regarding the available bond(s) as well as a market value for each offering. In an embodiment, the computer system 20 can separately list bond offerings of the same bond by different sellers. Alternatively, the computer system 20 can aggregate multiple offerings into a single listing. In the latter case, the computer system 20 can enable the user to expand an aggregated listing into its individual listings.

FIG. 11D shows an illustrative interface presenting a list of proposed trades for presentation to the user. As illustrated, a trade can include the proposed sale of one or more bonds in a portfolio and the proposed purchase of one or more bonds available on the market. Each trade can have a grade, indicating an effectiveness of the trade in meeting one or more goals defined by the user. Multiple proposed trades can be sorted according to their effectiveness, e.g., as indicated by the calculated grade.

FIG. 11E shows an illustrative interface which can display and enable a user to view, define, edit, and/or the like, various attributes of a portfolio strategy (optimal portfolio). As illustrated, the interface can include an area that includes various user interface controls that present and enable the modification of various portfolio attributes, and an area that enables priorities for attributes to be viewed and defined. The interface also can present a summary of some or all of the currently defined attributes for the portfolio strategy. Additionally, the interface can present a list of portfolios currently associated with the portfolio strategy, if any, as well as a list of portfolios that are not associated with any portfolio strategy and can be associated with the portfolio strategy being displayed. The user can select portfolio(s) to associate or no longer associate with the portfolio strategy.

FIG. 11F shows an illustrative interface which presents information regarding one or more possible trades for a portfolio. As illustrated, the interface can include various attributes of the optimal portfolio (portfolio structure) for the portfolio, the best available bonds to buy to align the portfolio with the optimal portfolio, and the top bonds in the portfolio to sell in order to better align the portfolio with the optimal portfolio. The interface can include data regarding one or more recommended trades for the portfolio, which can include data regarding one or more purchases and/or sales, as well as how the trade affects alignment of one or more attributes of the portfolio with the optimal portfolio.

In addition, the interface can enable the user to generate his/her own trade recommendation. The user can use any of various approaches for generating a trade recommendation. For example, the user can select to define a new trade recommendation from the start, e.g., by selecting create idea. Alternatively, the user can create a recommendation from a current recommendation by selectively removing or adding bonds to the list of bonds to buy or sell, e.g., by selecting to create a hypothetical. To keep a current recommendation, the user can select to duplicate a current recommendation before making one or more alterations. FIG. 11G shows the interface modified to enable the user to create a new trade recommendation. As illustrated, the interface can include regions for adding bond(s) to sell and/or buy as part of the trade. After each change to the trade, the interface can calculate and display a score for the trade.

While shown and described herein as a method and system for evaluating bond trades, such as in conjunction with managing a portfolio, it is understood that aspects of the invention further provide various alternative embodiments. For example, in one embodiment, the invention provides a computer program fixed in at least one computer-readable medium, which when executed, enables a computer system to evaluate bond trades. To this extent, the computer-readable medium includes program code, such as the portfolio program 30 (FIG. 1), which enables a computer system to implement some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as the portfolio program 30 (FIG. 1), which enables a computer system to implement some or all of a process described herein. In this case, a computer system can process a copy of the program code to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of the program code, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for evaluating bond trades. In this case, the generating can include configuring a computer system, such as the computer system 20 (FIG. 1), to implement the method of evaluating bond trades. The configuring can include obtaining (e.g., creating, maintaining, purchasing, modifying, using, making available, etc.) one or more hardware components, with or without one or more software modules, and setting up the components and/or modules to implement a process described herein. To this extent, the configuring can include deploying one or more components to the computer system, which can comprise one or more of: (1) installing program code on a computing device; (2) adding one or more computing and/or I/O devices to the computer system; (3) incorporating and/or modifying the computer system to enable it to perform a process described herein; and/or the like.

Additionally, it is understood that aspects of the invention can be directed to various solutions other than evaluating bond trades. For example, embodiments can be utilized to evaluate trades (e.g., purchase, sale, swap, and/or the like) of other types of investments, such as other types of securities. In an illustrative embodiment, the invention can be utilized to evaluate real estate trades. In this case, the invention can evaluate, for example, all properties (e.g., houses) for sale based on multiple attributes of the properties. Such attributes can include various combinations of: location (e.g., within a designated radius of a location, within designated towns, etc.), square feet, number of bedrooms, number of bathrooms, type of heating, whether air conditioning is included, lot size, waterfront, annual tax burden, school district, etc. For a user managing a portfolio of properties, the invention can be utilized to decide which properties are best to buy or sell. For a user seeking to purchase a single property, such as for his/her home, the invention can be utilized to determine which properties are best from the many available properties and many possible criteria.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A computer system for managing an investment portfolio including a plurality of portfolio investments, and facilitating trades for the investment portfolio that efficiently align the investment portfolio with target attributes for the investment portfolio, the computer system including:
a set of computing devices including means for managing a trade evaluation graphical user interface, the means for managing the trade evaluation graphical user interface including:
generating investment portfolio contribution data for the plurality of portfolio investments in the investment portfolio, wherein the investment portfolio contribution data includes, for each of the plurality of portfolio investments in the investment portfolio, a contribution to a value for each of a plurality of portfolio attributes of the investment portfolio;
generating trade evaluation data for a hypothetical trade for the investment portfolio using at least one of: the investment portfolio contribution data or available investments data, wherein the trade evaluation data includes a hypothetical trade score representing an effect of the hypothetical trade on the plurality of portfolio attributes of the investment portfolio in comparison to a plurality of target attributes for the investment portfolio;
generating the trade evaluation graphical user interface including: the hypothetical trade score, an available investment score for an available investment available for purchase, a portfolio investment score for a portfolio investment of the plurality of portfolio investments, and a set of user interface controls for enabling a user to request alterations to the hypothetical trade; and
providing the trade evaluation graphical user interface for presentation to the user evaluating the hypothetical trade.

2. The computer system of claim 1, wherein the generating the investment portfolio contribution data includes weighing each of the plurality of portfolio investments in the investment portfolio based on a market value of each of the plurality of portfolio investments and a portfolio value of the investment portfolio.

3. The computer system of claim 1, wherein the generating the investment portfolio contribution data includes accounting for a relative importance of each of the plurality of portfolio attributes of the investment portfolio.

4. The computer system of claim 1, wherein the generating the trade evaluation data for the hypothetical trade includes:
identifying a subset of a plurality of available investments for purchase that are most suitable for inclusion in the investment portfolio;
identifying a subset of the plurality of portfolio investments in the investment portfolio that are most suitable for removal from the investment portfolio;
generating and scoring a plurality of possible trades including at least one of the subset of the plurality of available investments and at least one of the subset of the plurality of portfolio investments, wherein the scoring is based on the effect of the hypothetical trade on the plurality of portfolio attributes of the investment portfolio with respect to the plurality of target attributes; and
selecting the hypothetical trade from the plurality of possible trades based on the scoring.

5. The computer system of claim 4, wherein the identifying acts include generating a distance measurement for each of the plurality of portfolio bonds and each of the plurality of available bonds, wherein the distance measurement represents a difference between a plurality of bond attributes of the bond and the plurality of target attributes.

6. The computer system of claim 1, further comprising, in response to receiving a user request generated using the trade evaluation graphical user interface:
dynamically adjusting the hypothetical trade, wherein the adjusting includes changing at least one of: a set of available investments included in the hypothetical trade or a set of portfolio investments included in the hypothetical trade;
recalculating the trade score for the adjusted hypothetical trade; and
updating the trade evaluation graphical user interface with the adjusted hypothetical trade and the recalculated trade score.

7. The computer system of claim 1, the set of computing devices further including means for managing a portfolio evaluation graphical user interface, the means for managing the portfolio evaluation graphical user interface including:
calculating a plurality of portfolio scores for a plurality of investment portfolios, wherein each portfolio score for each of the plurality of investment portfolios represents an extent of alignment of the plurality of portfolio attributes of the investment portfolio with the plurality of target attributes for the investment portfolio;
generating the portfolio evaluation graphical user interface including the portfolio score and investment portfolio information for a subset of the plurality of investment portfolios;
providing the portfolio evaluation graphical user interface for presentation to a user; and
in response to receiving a user request generated using the portfolio evaluation graphical user interface for one of the subset of the plurality of investment portfolios, generating the trade evaluation graphical user interface.

8. The computer system of claim 7, wherein the calculating the plurality of portfolio scores accounts for a relative importance of each of the plurality of portfolio attributes for each of the plurality of investment portfolios.

9. The computer system of claim 1, wherein the trade evaluation graphical user interface includes:
a first area for displaying a hypothetical trade score for each of a plurality of hypothetical trades;
a second area for concurrently displaying an available investment score for each of a plurality of available investments available for purchase, wherein the available investment score represents an effect on the plurality of portfolio attributes of the investment portfolio in comparison to the plurality of target attributes for the investment portfolio resulting from including the available investment in the investment portfolio; and
a third area for concurrently displaying a portfolio investment score for at least some of the plurality of portfolio investments, wherein the portfolio investment score represents an effect on the plurality of portfolio attributes of the investment portfolio in comparison to the plurality of target attributes for the investment portfolio resulting from removing the portfolio investment from the investment portfolio.

10. The computer system of claim 9, the means for managing the trade evaluation graphical user interface further including, for a selected hypothetical trade of the plurality of hypothetical trades and in response to a user request generated for the selected hypothetical trade using the graphical user interface, concurrently displaying in the first area of the trade evaluation graphical user interface:
a set of available investments selected from the plurality of available investments and included in the selected hypothetical trade; and
a set of portfolio investments selected from the plurality of portfolio investments and included in the selected hypothetical trade.

11. The computer system of claim 10, the means for managing the trade evaluation graphical user interface further including, in response to receiving a user request for the selected hypothetical trade, the user request generated using the trade evaluation graphical user interface:
dynamically adjusting the selected hypothetical trade, the adjusting including changing at least one of: the set of available investments included in the selected hypothetical trade or the set of portfolio investments included in the selected hypothetical trade;
recalculating the trade score for the selected hypothetical trade; and
updating the trade evaluation graphical user interface with the adjusted selected hypothetical trade and the recalculated trade score.

12. The computer system of claim 1, wherein the generating trade evaluation data includes calculating the hypothetical trade score using: a portfolio vector for the investment portfolio, a target portfolio vector for the plurality of target attributes, and a portfolio contribution vector for each of a set of available investments included in the hypothetical trade and each of a set of portfolio investments included in the hypothetical trade.

13. The computer system of claim 12, wherein the portfolio vector includes an attribute value for each of the plurality of portfolio attributes, wherein the target portfolio vector includes a target value for each of the plurality of portfolio attributes, and wherein the portfolio contribution vector includes a value for each of the plurality of portfolio attributes corresponding to a contribution of the investment to the attribute value for the investment portfolio.

14. The computer system of claim 12, wherein the portfolio contribution vector accounts for a relative importance of each of the plurality of portfolio attributes.

15. The computer system of claim 1, further comprising generating a target portfolio interface for presentation to the user, wherein the target portfolio interface includes a set of user interface controls for enabling the user to define the plurality of target attributes.

16. The computer system of claim 1, wherein the plurality of portfolio investments includes a plurality of bonds, and wherein the plurality of portfolio attributes includes at least five bond attributes.

17. A method of managing information for an investment portfolio including a plurality of portfolio investments and information regarding a set of hypothetical trades involving the investment portfolio, the method comprising:
displaying, on a graphical user interface, a trade score for each hypothetical trade in the set of hypothetical trades, wherein the trade score represents an effect of the hypothetical trade on a plurality of portfolio attributes of the investment portfolio in comparison to a plurality of target attributes for the investment portfolio;
concurrently displaying, on the graphical user interface, an available investment score for an available investment in a plurality of available investments for purchase, wherein the available investment score represents an effect on the plurality of portfolio attributes of the investment portfolio in comparison to the plurality of target attributes for the investment portfolio resulting from including the available investment in the investment portfolio; and
concurrently displaying, on the graphical user interface, a portfolio investment score for a portfolio investment of the plurality of portfolio investments, wherein the portfolio investment score represents an effect on the plurality of portfolio attributes of the investment portfolio in comparison to the plurality of target attributes for the investment portfolio resulting from removing the portfolio investment from the investment portfolio.

18. The method of claim 17, further comprising, on a computer system including at least one computing device, calculating the trade score using: a portfolio vector for the investment portfolio, a target portfolio vector for the plurality of target attributes, and a portfolio contribution vector for each of the set of available investments included in the hypothetical trade and each of the set of portfolio investments included in the hypothetical trade, wherein the portfolio vector includes an attribute value for each of the plurality of portfolio attributes, wherein the target portfolio vector includes a target value for each of the plurality of portfolio attributes, and wherein the portfolio contribution vector includes a value for each of the plurality of portfolio attributes corresponding to a contribution of the investment to the attribute value for the investment portfolio.

19. A computer-implemented method of managing an investment portfolio including a plurality of portfolio bonds, the method comprising:
generating, by a computer system including at least one computing device, investment portfolio contribution data for the plurality of portfolio bonds in the investment portfolio, wherein the investment portfolio contribution data includes, for each of the plurality of portfolio bonds in the investment portfolio, a contribution to an attribute value for each of a plurality of portfolio attributes of the investment portfolio;
generating, by the computer system, trade evaluation data for a hypothetical trade for the investment portfolio using the investment portfolio contribution data, wherein the trade evaluation data includes a hypothetical sale of a portfolio bond in the investment portfolio, wherein the trade evaluation data includes data regarding an effect of the hypothetical trade on the plurality of portfolio attributes of the investment portfolio in comparison to a plurality of target attributes of a target portfolio for the investment portfolio; and
providing, by the computer system, the trade evaluation data for use by a user in evaluating the hypothetical trade.

20. The method of claim 19, wherein the generating the trade evaluation data for the hypothetical trade includes:
identifying a subset of a plurality of available bonds for purchase that are most suitable for inclusion in the investment portfolio, wherein the identifying includes generating a distance measurement for each of the plurality of available bonds, wherein the distance measurement represents a difference between a plurality of bond attributes of the available bond and the plurality of target attributes of the target portfolio;
identifying a subset of the plurality of portfolio bonds in the investment portfolio that are most suitable for removal from the investment portfolio, wherein the identifying includes generating a distance measurement for each of the plurality of portfolio bonds, wherein the distance measurement represents a difference between a plurality of bond attributes of the portfolio bond and the plurality of target attributes of the target portfolio;
generating and scoring a plurality of possible trades including at least one of the subset of the plurality of available bonds and at least one of the subset of the plurality of portfolio bonds, wherein the scoring is based on the effect of the hypothetical trade on the plurality of portfolio attributes of the investment portfolio with respect to the plurality of target attributes of the target portfolio as determined using the distance measurements; and
selecting the hypothetical trade from the plurality of possible trades based on the scoring.
